(19) United States
(12) Patent Application Publication
(10) Pub. No.: US 2023/0264419 A1
(43) Pub. Date: Aug. 24, 2023

(54) THREE-DIMENSIONAL (3D) PRINTER HOTEND AND NOZZLE CHANGER SYSTEM

(71) Applicant: 2679667 ONTARIO INC., Cambridge (CA)

(72) Inventor: Christopher John Elmer Gibson, Cambridge (CA)

(73) Assignee: 2679667 ONTARIO INC., Cambridge (CA)

(21) Appl. No.: 18/111,780

(22) Filed: Feb. 20, 2023

Related U.S. Application Data
(60) Provisional application No. 63/311,938, filed on Feb. 18, 2022.

(51) Int. Cl. B29C 64/259; B29C 64/307; B29C 64/209; B29C 64/118; B33Y 30/00; B33Y 40/00; B33Y 10/00

(52) U.S. Cl. CPC B29C 64/259; B29C 64/307; B29C 64/209; B29C 64/118; B33Y 30/00; B33Y 40/00; B33Y 10/00

(57) ABSTRACT

The present disclosure describes a 3D printer comprising a core exchanger mechanism to store filament cores, a hotend, an actuation arm and a cutting mechanism to sever the filament. The cores are swappable by the core exchanger mechanism to provide a variety of filament to the 3D printed object during printing. A coreless hotend for use with a 3D printer is also provided, comprised of a receptacle to receive and store cores of the 3D printer during 3D printing. The coreless hotend is also comprised of a locking mechanism to lock and release the cores from the receptacle to replace the core with another core.

### FIELD

This disclosure generally relates to the field of 3D printing, and more specifically to changer systems for 3D printer hotends and nozzles.

### BACKGROUND

In Fused Deposition Modeling (FDM) 3D printing there are a multitude of ways to produce multi-colored 3D print outputs. The problem with all of them is that the changeover between colors is so long and so much material that it can add significant waste and time to the 3D printing process. For instance, if a single-color print uses 100 grams of material and takes 4 hours, if converted to a multi-color print it may take 24 hours and use 1 kilogram of material. This is the major barrier to mass adoption of color FDM technology. Also, the longer a multicolor print takes, the more challenging it is to synchronize the color lengths to enter the extruder hotend at the correct time. The color purging is required because the previous color remains in the nozzle when the next color filament is introduced, and the previous color must be completely purged out by the new color before printing can resume. The purge amount is usually deposited to a waste bin or a purge block. The printing of a purge block is time consuming and wasteful. The gold standard in multicolor filament printing color changeover would be to switch filaments without the need for any purge at all. This can be accomplished with a multi-head 3d printer each loaded with its own color or material of filament, but the issue with multi-heads is that each of the heads added increases the complexity of the 3D printer dramatically by adding a heating element and temperature sensor and a filament feeding motor and extruder. The result is that the electronics become more complex and each of the heads take up additional space in the 3D printer and because of space constraints the maximum number of printheads is usually restricted to less than 6. A 6-print head 3D printer is also much more expensive because of the extra electronics and hardware they can cost thousands of dollars more than a single printhead system. The multi-head 3D printer also requires a customer to purchase a new machine, while there are tens of millions of existing 3D printers in the world already owned by users that would need to be replaced. A system that could be retrofit to existing 3D printers and provide zero purging multicolor capability with a much higher number of colors like twenty five or more in the space of a standard desktop consumer grade 3D printer would be very useful. Finding a way to eliminate the need for the previous color to be purged would be a large step towards mass adoption of multicolor 3D printing. That is the subject of the present disclosure; a system that changes hotend cores/nozzles as needed during a multicolor 3D print using the same core/nozzle each time for the same color without needing to purge out the previous color and being small enough to incorporate into existing consumer grade desktop 3D printing systems.

Tool changers are known in the art of CNC milling and have been used in this industry for decades. There are no other directly comparable systems to the one described herein in the 3D printing space. The closest analogue is the tool changers used in CNC machining.

However, there are purging systems in 3D printing, like the one described in US Patent Publication No. 20200307094 (Gibson) that have hardware catchers that extend out over the print area to catch the color purge waste. The present disclosure shares some similarities to that, in that it has a tool arm that extends over the print area to remove the hotend and cut the filament and then retracts back out of the way. Otherwise, both serve two separate purposes, albeit in the same multicolor 3d printing space.

### SUMMARY

In an aspect, the present disclosure provides a three-dimensional (3D) printer comprising: a core exchanger mechanism to swap a plurality of hotend cores, the plurality of hotend cores containing a filament to print a 3D object; a hotend comprised of a first hotend core, the hotend connected to an extruder to heat and extrude the filament, the hotend and the extruder operatively engaged with the core exchanger mechanism; an actuation arm connected to the core exchange mechanism, the actuation arm configured to engage and selectively swap the plurality of hotend cores; and, a cutting mechanism to sever the filament, wherein the first hotend core is separated from the hotend once the filament is severed and swapped with a second core of the plurality of hotend cores of the core exchanger mechanism.

In another aspect, the present disclosure provides a coreless hotend for use with a three-dimensional (3D) printer, the coreless hotend comprising: a receptacle to receive and store a core of the 3D printer during 3D printing; and, a locking mechanism to releasably lock the core within the receptacle of the coreless hotend, wherein the locking mechanism is configured to release the core from the receptacle to replace the core with another core, the other core locked within the receptacle by the locking mechanism to provide for multi filament 3D printing.

### BRIEF DESCRIPTION OF THE DRAWINGS

The following figures serve to illustrate various embodiments of features of the disclosure. These figures are illustrative and are not intended to be limiting.

FIG. 1 is a perspective view of a 3D printer according to an embodiment of the present disclosure;

FIG. 2 is an exploded view of a core exchanger of the 3D printer of FIG. 1, according to an embodiment of the present disclosure;

FIG. 3 is an exploded view of a core of the 3D printer of FIG. 1, according to an embodiment of the present disclosure;

FIG. 4 is an exploded view of a hotend without a core of the 3D printer of FIG. 1, according to an embodiment of the present disclosure;

FIG. 5A is a top view of the hotend of FIG. 4 in an unlocked position, according to an embodiment of the present disclosure;

FIG. 5B is a cross-sectional view of the hotend of FIG. 5A taken along the lines B-B, according to an embodiment of the present disclosure;

FIG. 6A is a top view of the hotend of FIG. 4 in a locked position, according to an embodiment of the present disclosure;

FIG. 6B is a cross-sectional view of the hotend of FIG. 6A taken along the lines A-A, according to an embodiment of the present disclosure;

FIG. 7A is a top view of the core storage of the 3D printer of FIG. 1 in an unloaded position, according to an embodiment of the present disclosure;

FIG. 7B is a cross-sectional view of the core storage of FIG. 7A taken along the lines A-A, according to an embodiment of the present disclosure;

FIG. 8A is a top view of the core storage of the 3D printer of FIG. 1 in a loaded position, according to an embodiment of the present disclosure;

FIG. 8B is a cross-sectional view of the core storage of FIG. 8A taken along the lines B-B, according to an embodiment of the present disclosure;

FIG. 9 is a perspective view of a preheater of the 3D printer of FIG. 1 in a disengaged position, according to an embodiment of the present disclosure;

FIG. 10 is a perspective view of the preheater of the 3D printer of FIG. 1 in an engaged position, according to an embodiment of the present disclosure;

FIG. 11A is a top view of the integrated cutter of the 3D printer of FIG. 1 in an uncut position, according to an embodiment of the present disclosure;

FIG. 11B is a cross-sectional view of the integrated cutter of FIG. 11A taken along the lines C-C, according to an embodiment of the present disclosure;

FIG. 12A is a top view of the integrated cutter of the 3D printer of FIG. 1 in a cut position, according to an embodiment of the present disclosure;

FIG. 12B is a cross-sectional view of the integrated cutter of FIG. 12A taken along the lines D-D, according to an embodiment of the present disclosure;

FIG. 13A is a perspective view of a core for use with the 3D printer of FIG. 1, according to another embodiment of the present disclosure;

FIG. 13B is a cross-sectional view of the core of FIG. 13A taken along the lines A-A, according to another embodiment of the present disclosure;

FIG. 14A is a top view of a disconnected cutter of the 3D printer of FIG. 1, in step 1 of cutting the filament, according to an embodiment of the present disclosure;

FIG. 14B is a cross-sectional view of the disconnected cutter of FIG. 14A taken along the lines A-A, according to an embodiment of the present disclosure;

FIG. 15A is a top view of a disconnected cutter of the 3D printer of FIG. 1, in step 2 of cutting the filament, according to an embodiment of the present disclosure;

FIG. 15B is a cross-sectional view of the disconnected cutter of FIG. 15A taken along the lines B-B, according to an embodiment of the present disclosure;

FIG. 16A is a top view of a disconnected cutter of the 3D printer of FIG. 1, in step 3 of cutting the filament, according to an embodiment of the present disclosure;

FIG. 16B is a cross-sectional view of the disconnected cutter of FIG. 16A taken along the lines B-B, according to an embodiment of the present disclosure;

FIG. 17A is a top view of a disconnected cutter of the 3D printer of FIG. 1, in step 4 of cutting the filament, according to an embodiment of the present disclosure;

FIG. 17B is a cross-sectional view of the disconnected cutter of FIG. 17A taken along the lines B-B, according to an embodiment of the present disclosure;

FIG. 18A is a top view of a disconnected cutter of the 3D printer of FIG. 1, in step 5 of cutting the filament, according to an embodiment of the present disclosure;

FIG. 18B is a cross-sectional view of the disconnected cutter of FIG. 18A taken along the lines C-C, according to an embodiment of the present disclosure;

FIG. 19A is a top view of a disconnected cutter of the 3D printer of FIG. 1, in step 6 of cutting the filament, according to an embodiment of the present disclosure;

FIG. 19B is a cross-sectional view of the disconnected cutter of FIG. 19A taken along the lines C-C, according to an embodiment of the present disclosure;

FIG. 20 is a perspective view of the 3D printer with the nozzle unscrewed, according to an embodiment of the present disclosure;

FIG. 21A is a top view of a nozzle unscrewer mechanism for use with the 3D printer of FIG. 1, in a first step of removing the nozzle, according to another embodiment of the present disclosure;

FIG. 21B is a cross-sectional view of the nozzle unscrewer of FIG. 21A taken along the lines A-A, according to another embodiment of the present disclosure;

FIG. 22A is a top view of the nozzle unscrewer mechanism of FIG. 21A, in a second step of removing the nozzle, according to another embodiment of the present disclosure;

FIG. 22B is a cross-sectional view of the nozzle unscrewer of FIG. 22A taken along the lines B-B, according to another embodiment of the present disclosure;

FIG. 23A is a top view of the nozzle unscrewer mechanism of FIG. 21A, in a third step of removing the nozzle, according to another embodiment of the present disclosure;

FIG. 23B is a cross-sectional view of the nozzle unscrewer of FIG. 23A taken along the lines C-C, according to another embodiment of the present disclosure;

FIGS. 24 to 44 are perspective views of the various steps to exchange a core of the 3D printer of FIG. 1, according to an embodiment of the present disclosure;

FIG. 45A is a top view of the filament cutting step shown in FIG. 27, according to an embodiment of the present disclosure;

FIG. 45B is a cross-sectional view of FIG. 45A taken along the lines A-A, according to an embodiment of the present disclosure;

FIG. 46A is a top view of the filament cutting step shown in FIG. 29, according to an embodiment of the present disclosure;

FIG. 46B is a cross-sectional view of FIG. 46A taken along the lines B-B, according to an embodiment of the present disclosure;

FIG. 47A is a top view of the filament cutting step shown in FIG. 30, according to an embodiment of the present disclosure;

FIG. 47B is a cross-sectional view of FIG. 47A taken along the lines C-C, according to an embodiment of the present disclosure;

FIG. 48 is a perspective view of a 3D printer having a linear storage mechanism, the linear storage mechanism moving in a first step according to another embodiment of the present disclosure;

FIG. 49 is a perspective view of a 3D printer having the linear storage mechanism of FIG. 48, the linear storage mechanism moving in a second step according to another embodiment of the present disclosure;

FIG. 50 is a perspective view of a 3D printer having the linear storage mechanism of FIG. 48, the linear storage mechanism moving in a third step according to another embodiment of the present disclosure; and,

FIG. 51 is a perspective view of a multi core exchange arm for use with the 3D printer of FIG. 1, according yet another embodiment of the present disclosure.

### DETAILED DESCRIPTION

A CNC computer numerical controlled tool changer, which has an arm that extends to the print head and removes the currently in used hotend, cuts the filament to detach the hotend from the print head, then stows the hotend outside the print area, then replaces the hotend/nozzle with another one in reverse procedural order. In a preferred embodiment, the hotend core is held in place below the coreless hotend and the filament cutter severs the filament, allowing the core to be completely detached from the hotend of the 3D printer so that it may be stowed and/or replaced with another core. In one embodiment the hotend is changed and stored, while in another only the nozzle is changed and stored. The main difference between the nozzle and hotend is that the hotend contains the nozzle and a heat break transition zone while the nozzle does not.

A worker skilled in the art will appreciate that there are many types of tool changers that can be used in the present disclosure. Some store the tools in rotary wheels, along the edge of the machine, or in a complex robotic filing system. Any of these will works for storing the unused nozzle or hotend, but the combination of removing the hotend and cutting the filament is the main aspect of the present disclosure, specific to 3D printing. In one embodiment the cutter can be stationary and the extruder must move to it, while in another embodiment the extruder is stationary and the cutter extends to cut the filament and retracts to stow out of the way.

There are many ways that the hotend can be unlocked, either using a servo mounted to the x carriage, using a servo attached to the stationary edge of the Y gantry, or using the x stepper to press the hotend release button against a stationary arm for example. A worker skilled in the art would appreciate that although these means to unlock the hotend are mentioned, any way to unlock the hotend would still be covered by the present disclosure.

There are many ways that the filament cutter may affect the separating of the filament from the 3D printer. For example, a rotating knife edge, a pinching knife (e.g. side cutters or standard shears), an electronic or pneumatic actuator with a bladed end may shear the filament, or the cutting tool can be attached to the tool actuation arm or be on an independently controlled actuator. A worker skilled in the art would appreciate that there are many ways for the filament to be sheared and separated from the 3D printer, which would form part of the present disclosure.

The following variations of the core/nozzle storage system could be incorporated into the present disclosure: automatic touch-off probe/switch can locate the nozzle compared to the tool changing arms, use steel collars to stick the nozzles to the tool changer arm, use steel and magnets on the nozzles to hold the nozzles in the tool changer, or use spring loaded snap in collar to secure the core/nozzle in the tool changer arm during movement. Again, a worker skilled in the art would appreciate that there are many ways for the core/nozzle to be separated from the 3D printer, which would still form part of the present disclosure.

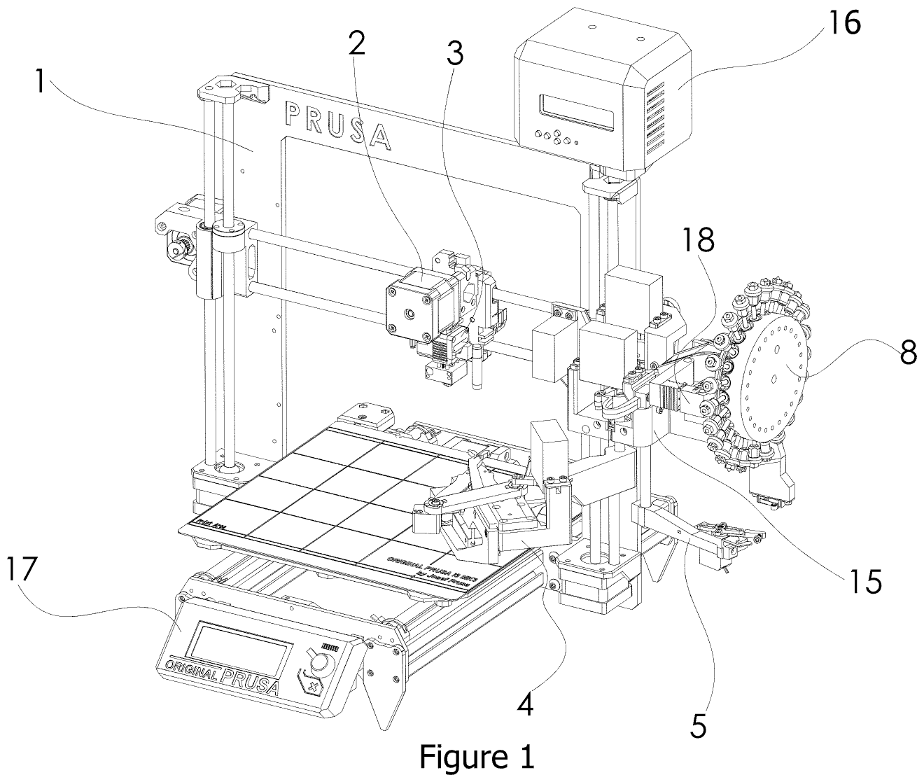

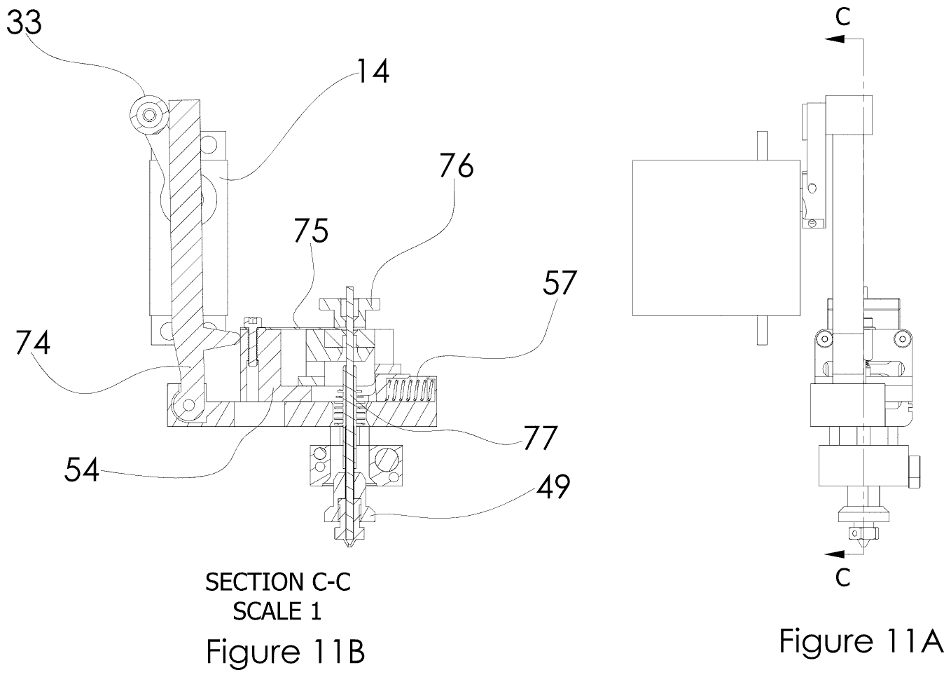

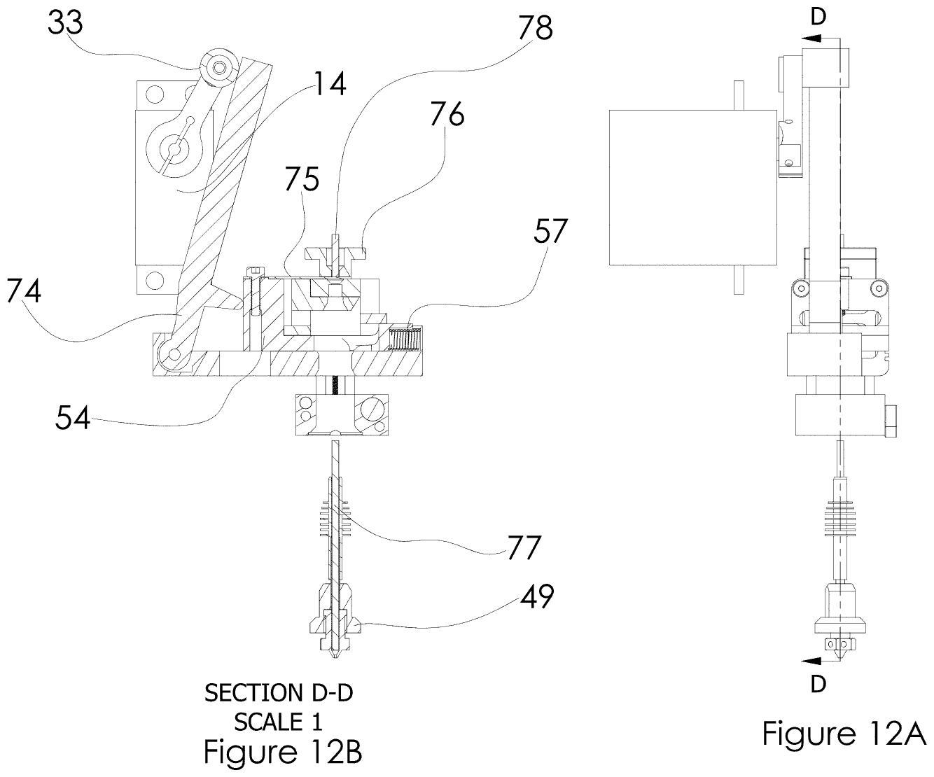

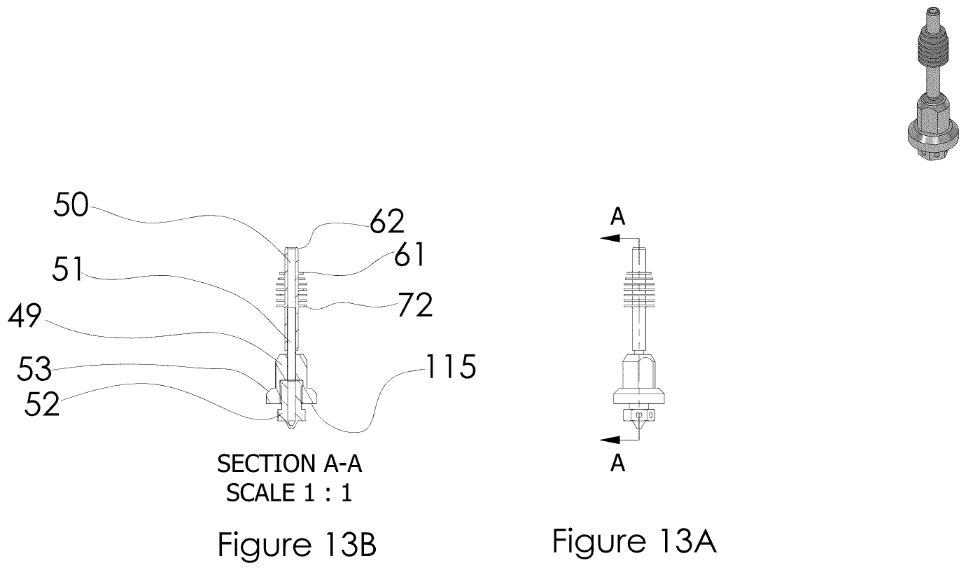

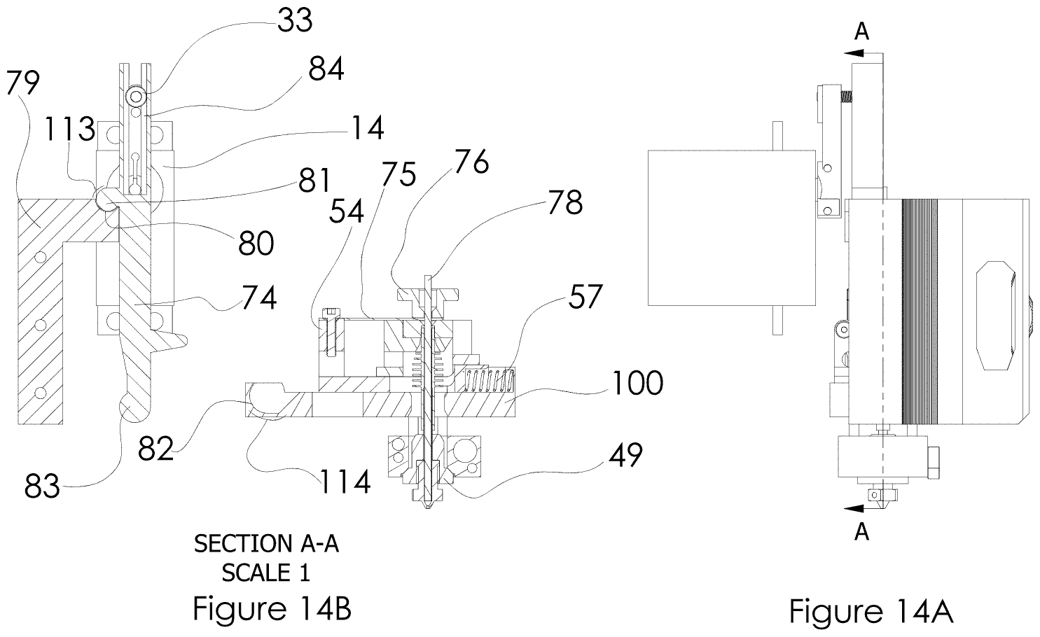

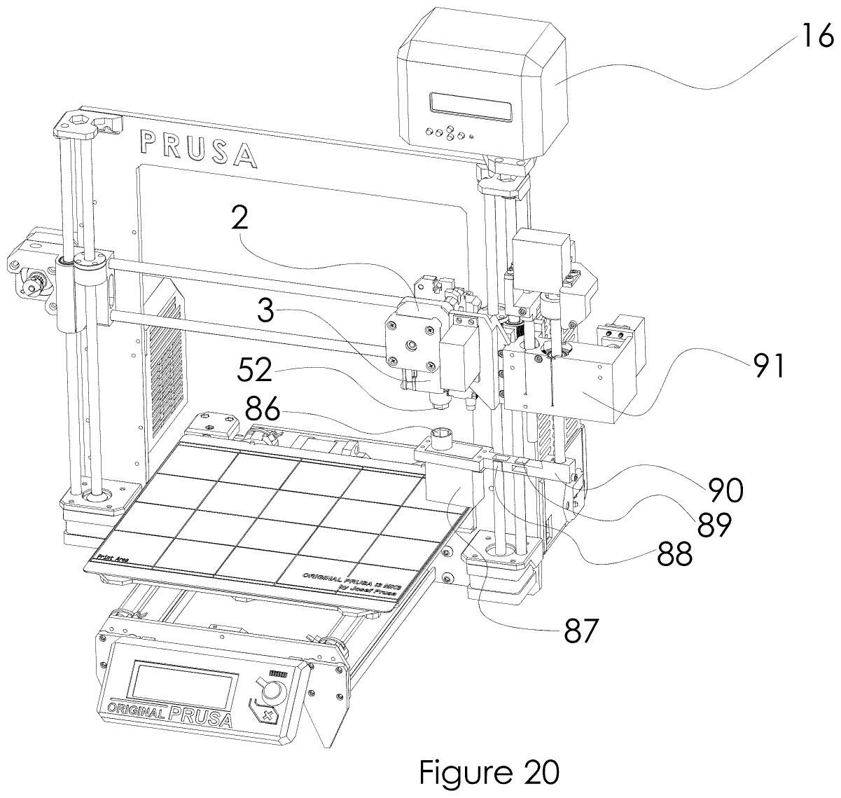

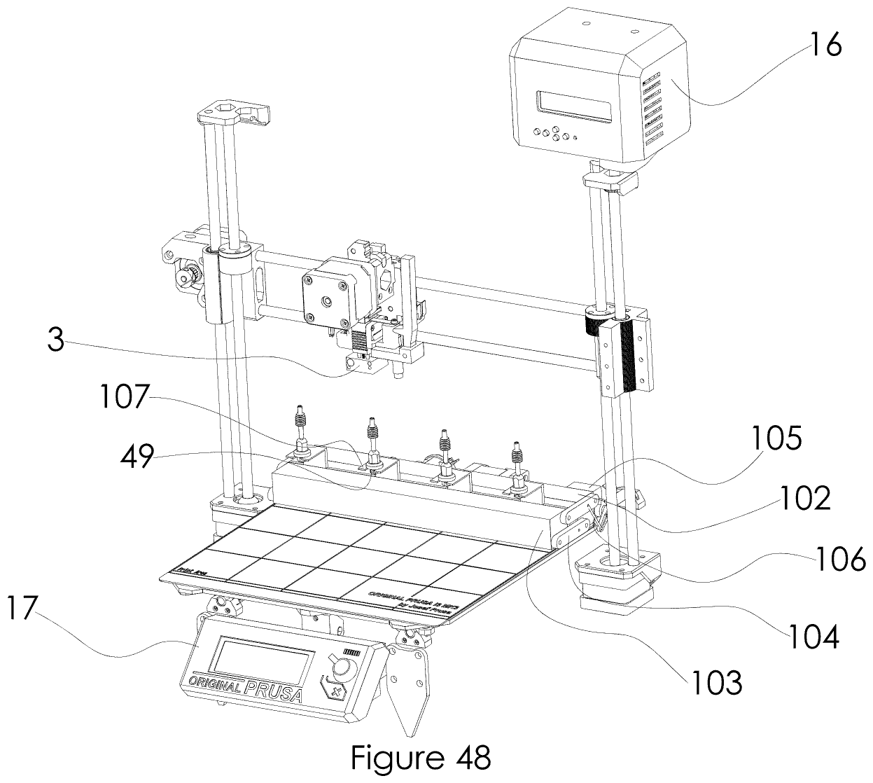

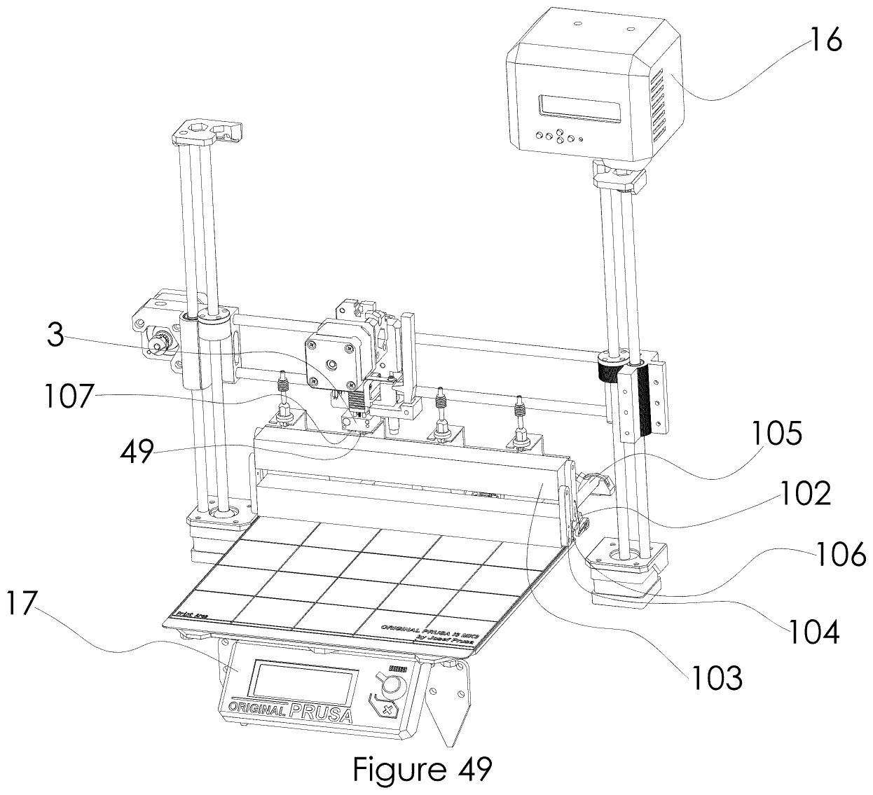

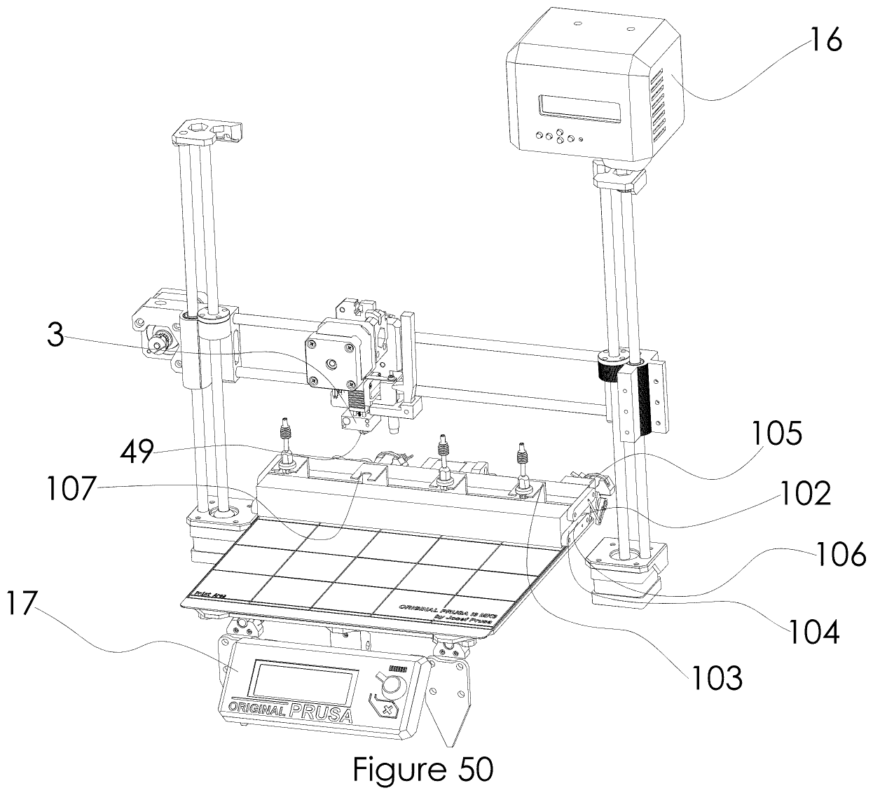

With reference to FIG. 1 and according to an embodiment of the present disclosure, a CNC controlled core exchanger mechanism 15 is operatively engaged with a CNC controlled 3D printer 1, additionally a coreless hotend 3 operatively engaged with the extruder 2 of the 3D printer 1. The core exchanger mechanism engaged 15 with the core storage mechanism 8, and a core preheater 18, and a filament cutter 4, and an actuation arm 5. The actuation arm 5 being substitutable with a nozzle unscrewing mechanism 91 (shown in FIGS. 20 to 23B), or the dual core exchanger actuation arm 98 of FIG. 13. Meanwhile, the filament cutter 4 is substitutable with either an integrated cutter shown in FIGS. 11 to 12 or a disconnected cutter shown in FIGS. 14 to 19. The core storage mechanism is substitutable with either the arc core storage mechanism 95 shown in FIG. 48, or the linear storage mechanism 96 shown in FIG. 49, or the chain magazine storage mechanism 97 shown in FIG. 50.

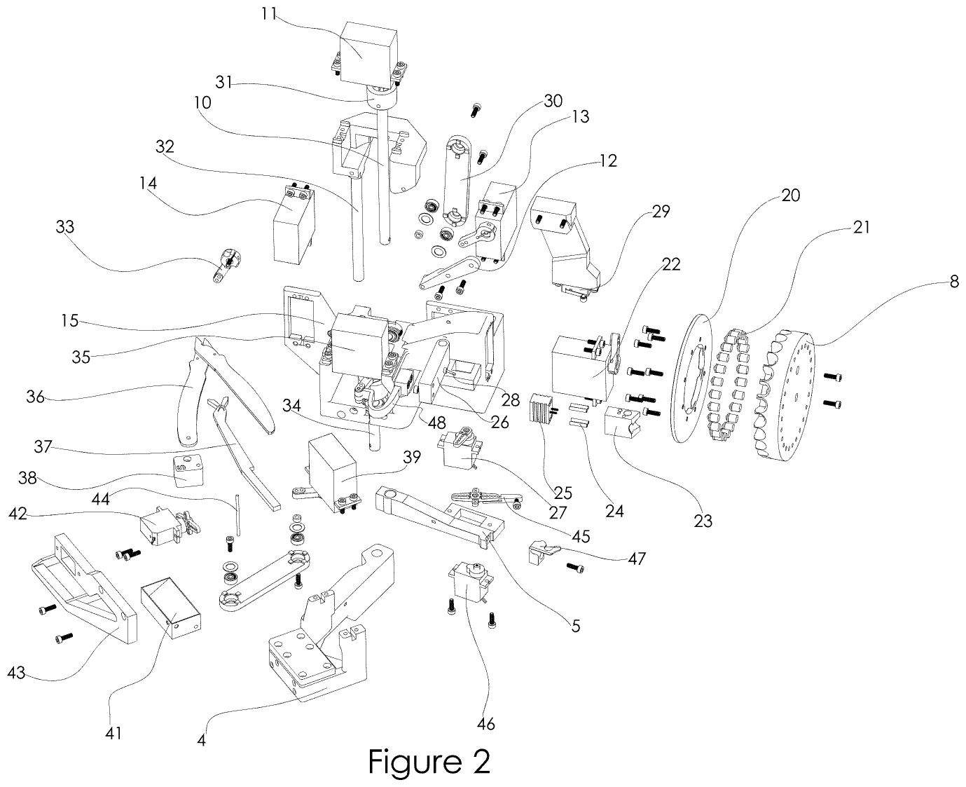

With reference to FIG. 2 and according to an embodiment of the present disclosure, the core exchanger mechanism 15 is comprised of an actuation arm rotation shaft 10, actuation arm rotating shaft motor 11, actuation arm Z axis arm 12, actuation arm Z axis motor 13, coreless hotend lock motor 14, core exchanger mechanism 15, core exchanger CNC controller 16, printer CNC controller 17, core preheater 18, core storage plunger base 19, preheater-heater block 23, preheater-heat break 24, preheater-cooling block 25, preheater-rotation arm 26, preheater-rotation motor 27, preheater-motor to arm connecting rod 28, check sensor 29, connecting arm 30, motor to shaft connection horn 31, anti rotation shaft 32 and coreless hotend lock actuator 33. The actuation arm 5 is further comprised of the actuation arm-core lock 45, actuation arm-core lock motor 46, and end effector 47. The filament cutter 4 is comprised of connecting arm 30, motor to shaft connection horn 31, anti rotation shaft 32, coreless hotend lock actuator 33, filament cutter rotation shaft 34, filament cutter rotation motor 35, filament cutter blade 36, filament cutting guide 37, filament cutter to motor connecting clamp 38, filament cutter actuation motor 39, filament cutter arm 40, filament cuttings waste bin 41, filament cuttings waste bin dump motor 42, filament cuttings waste bin bracket 43, filament cuttings waste bin to dump motor connecting arm 44.

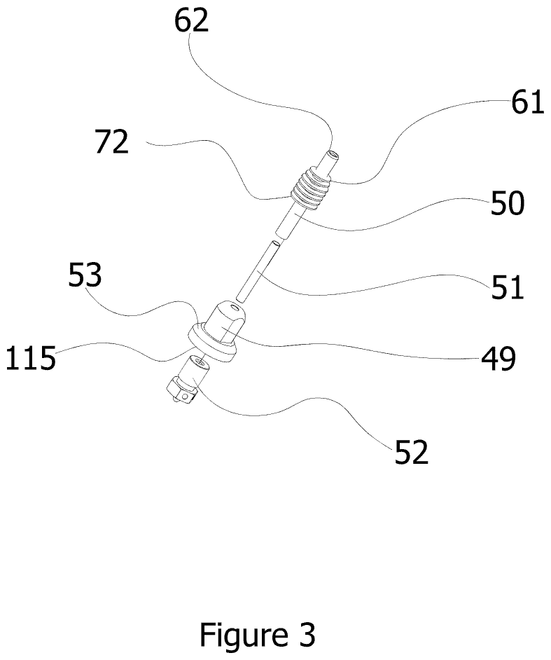

With reference to FIG. 3 and according to an embodiment of the present disclosure, the core 49 is comprised of cooling fins 50, heatbreak 51, nozzle 52, and core tapered mating surface 53. The core heatbreak 51 is comprised of a low thermal conductivity material like 304 stainless steel in a low thermal transfer package like that of a thin walled surgical tube.

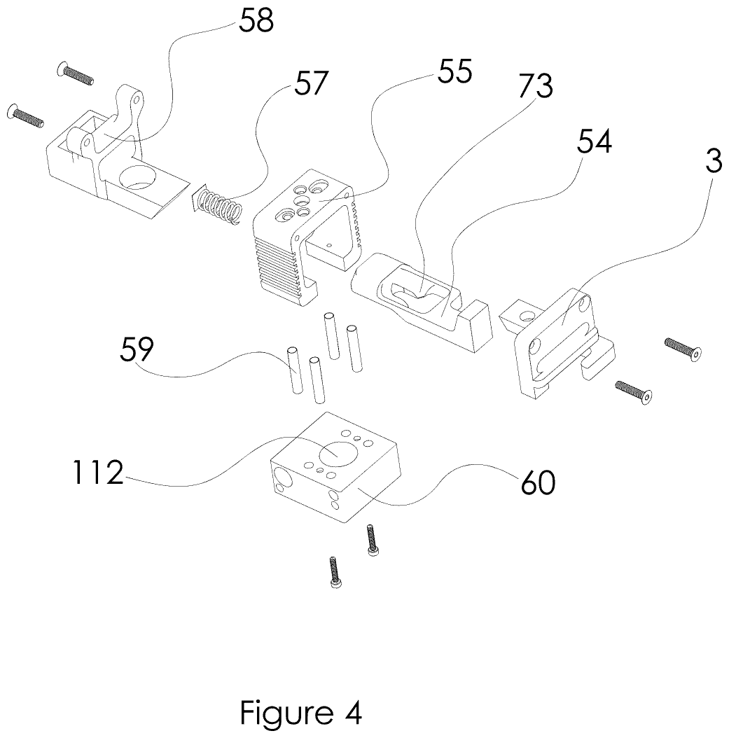

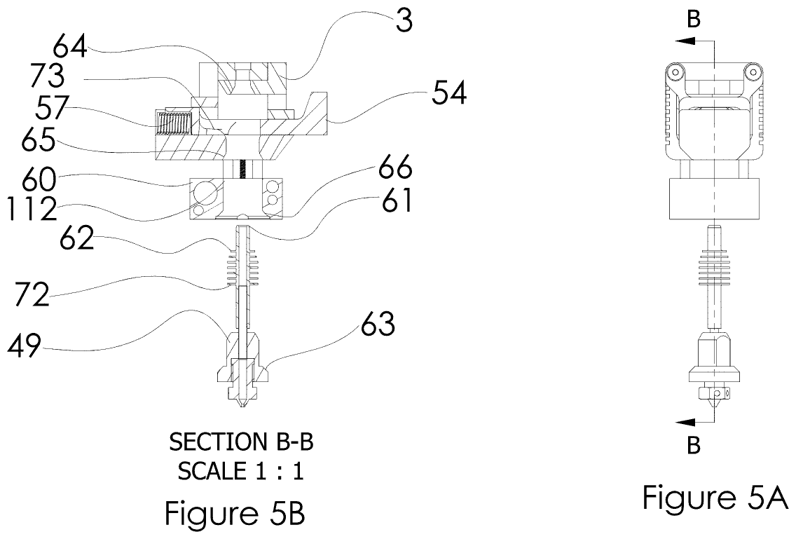

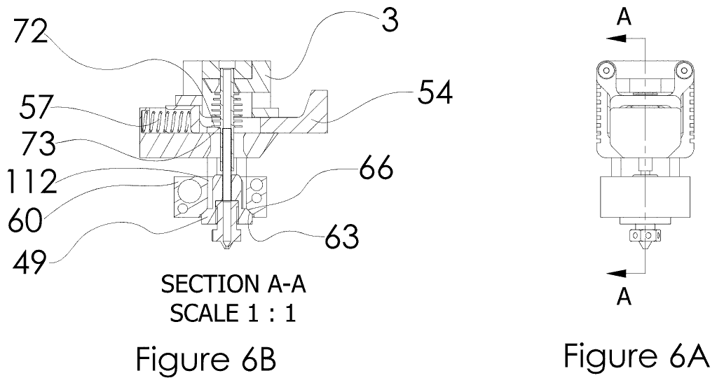

With reference to FIGS. 4, 5A, 5B, 6 and 7 and according to an embodiment of the present disclosure, the coreless hotend is comprised of a core lock 54, a spring 57, a cooling block 55, a spring case 58, a heatbreak 59 and a heater block 60. The heatbreak 59 provides a thermal bridge to isolate the heat of the heater block 60 from the cooling block 55, preferably comprised of a low thermal conductivity material like 304 stainless steel in a low thermal transfer package like that of a thin walled surgical tubes. The heaterblock 60 contains a heater 99 that is a thermal device providing heat to the heaterblock 60, the temperature of the heater 99 is monitored by the temperature sensor 100 of the Printer CNC controller 17. The coreless hotend differs from the standard 3D printer hotends because it separates a standard hotend into 2 components with a bridge to maintain the structure of the coreless hotend when the core is removed. Both parts having a cold side, hot side, heatbreak, and thermally conductive mating surface. But only the coreless hotend having a heater and temperature sensor. In short, it lacks a permanent connection between the heating element and the filament melt zone, these elements comprising the core of a standard 3d printer hotend. This allows the core to be removed from the coreless hotend and stowed, and for the 3D printer to melt and extrude filament during its normal printing operations a core must be inserted and locked into the coreless hotend.

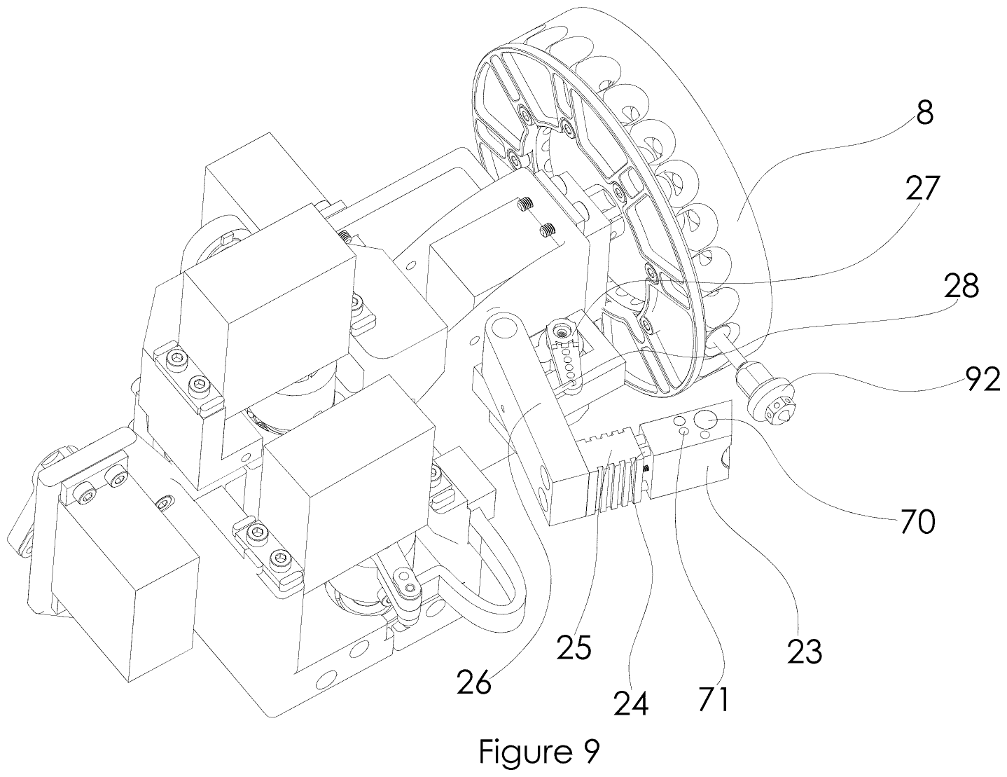

With reference to FIG. 9 and according to an embodiment of the present disclosure, the preheater is comprised of core storage mechanism 8, core Stowed in receptacle 9, actuation arm rotation shaft 10, actuation arm rotating shaft motor 11, actuation arm Z axis arm 12, actuation arm Z axis motor 13, coreless hotend lock motor 14, core exchanger mechanism 15, core exchanger CNC controller 16, printer CNC controller 17, core preheater 18, core storage plunger base 19, core storage plunger top 20, spring loaded ball bearing plungers 21, core storage mechanism rotation motor 22, preheater-heater block 23, preheater-heat break 24, preheater-cooling block 25, preheater-rotation arm 26, preheater-rotation motor 27, and preheater-motor to arm connecting rod 28.

With reference to FIGS. 11A and 11B and according to an embodiment of the present disclosure, the integrated cutter is a variation of the standard coreless hotend 3 and is additionally comprised of a coreless hotend lock motor 14, coreless hotend lock actuator 33, core lock 54, spring 57, cutting lever 74, blade 75, and blade guide 76.

With reference to FIGS. 14A and 14B and according to an embodiment of the present disclosure, the disconnected cutter is a variation of the standard coreless hotend 3 comprised of coreless hotend lock motor 14, coreless hotend lock actuator 33, core lock 54, spring 57, cutting lever 74, blade 75, blade guide 76, filament 77, core exchanger to printer mounting bracket 79, first pocket 80, first pivot 81, second pocket 82, second pivot 83, and horn channel 84.

With reference to FIG. 20 and according to an embodiment of the present disclosure, the nozzle unscrewer is comprised of socket 86, socket motor 87, first sensor 88, second sensor 89, unscrewing arm 90, and nozzle unscrewing mechanism 91.

With reference to FIGS. 1 to 51, the components are as follows:
1. 3D printer
2. Extruder
3. Coreless hotend
4. Filament Cutter
5. Actuation arm
6. Empty core receptacle
7. core storage receptacle selector motor
8. Core storage mechanism
9. Core Stowed in receptacle.
10. Actuation arm rotation shaft
11. Actuation arm rotating shaft motor
12. Actuation arm Z axis arm
13. Actuation arm Z axis motor
14. Coreless hotend lock motor
15. Core exchanger mechanism
16. Core exchanger CNC controller
17. Printer CNC controller
18. Core preheater
19. Core storage plunger base
20. Core storage plunger top
21. Spring loaded ball bearing plungers
22. Core storage mechanism rotation motor
23. Preheater-heater block
24. Preheater-heat break
25. Preheater-cooling block
26. Preheater-rotation arm
27. Preheater-Rotation motor
28. Preheater-motor to arm connecting rod
29. Check sensor
30. Connecting arm
31. Motor to shaft connection horn
32. Anti rotation shaft
33. Coreless hotend lock actuator
34. Filament cutter rotation shaft
35. Filament cutter rotation motor
36. Filament cutter blade
37. Filament cutting guide
38. Filament cutter to motor connecting clamp
39. Filament cutter actuation motor
40. Filament cutter arm
41. Filament cuttings waste bin
42. Filament cuttings waste bin dump motor
43. Filament cuttings waste bin bracket
44. Filament cuttings waste bin to dump motor
45. Actuation arm-Core lock
46. Actuation arm-Core lock motor
47. End effector
48. Motor vibration damper
49. Core
50. Cooling fins
51. Heatbreak
52. Nozzle
53. Core tapered mating surface
54. Core lock
55. Cooling block
56. Temperature sensor
57. Spring
58. Spring case
59. Heatbreak
60. Heater block
61. Tip
62. Fin
63. Taper
64. Tip Alignment guide
65. Fin Alignment guide
66. Heater block Taper
67. Core locking surface
68. Core lock locking surface
69. Core storage tip alignment guide
70. Core storage fin alignment guide
71. Core storage receptacle
72. Preheater-heating element
73. Preheater-temperature sensor
74. Cutting lever
75. Blade
76. Blade guide
77. Filament
78. Cut Filament
79. Core exchanger to printer mounting bracket
80. Pocket one
81. Pivot one
82. Pocket two
83. Pivot two
84. Horn channel
85. Clearance between level and pocket 2
86. Socket
87. Socket motor
88. Sensor one
89. Sensor two
90. Unscrewing arm
91. Nozzle unscrewing mechanism
92. secondary core
93. Filament cutting guide alignment hole
94. Filament cut
95. Arc core storage mechanism (FIG. 48)
96. Linear storage mechanism (FIG. 49)
97. Chain magazine storage mechanism (FIG. 50)
98. Dual arm (FIG. 13)
99. Heater
100. Coreless hotend with disconnected cutter
101. Coreless hotend with integrated cutter
102. Linear Core storage
103. Linear Core storage lift bar
104. Linear Core storage pivot bars
105. Linear Core storage Pivot motor
106. Linear Core storage Motor connection rod
107. Linear Core storage end effector array
108. Multi core exchanging arm
109. Multi core exchanging actuation shaft
110. Core lock one
111. Core lock two
112. Core receptacle
113. Fulcrum one
114. Fulcrum two
115. Core Parallel surface
116. End effector Parallel surface

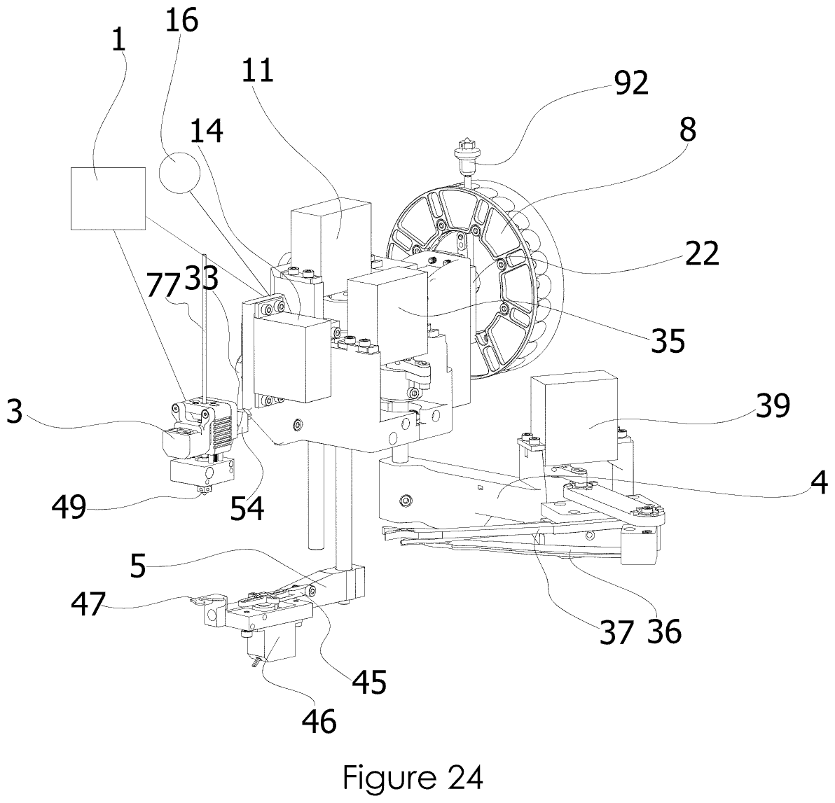

The process of a standard core exchange is described. The process begins in FIG. 24 in the left side isometric view, with the end effector 47 placed directly under the core 49 while it's locked in the coreless hotend 3. The core exchanger CNC controller 16 receives a signal to exchange the cores.

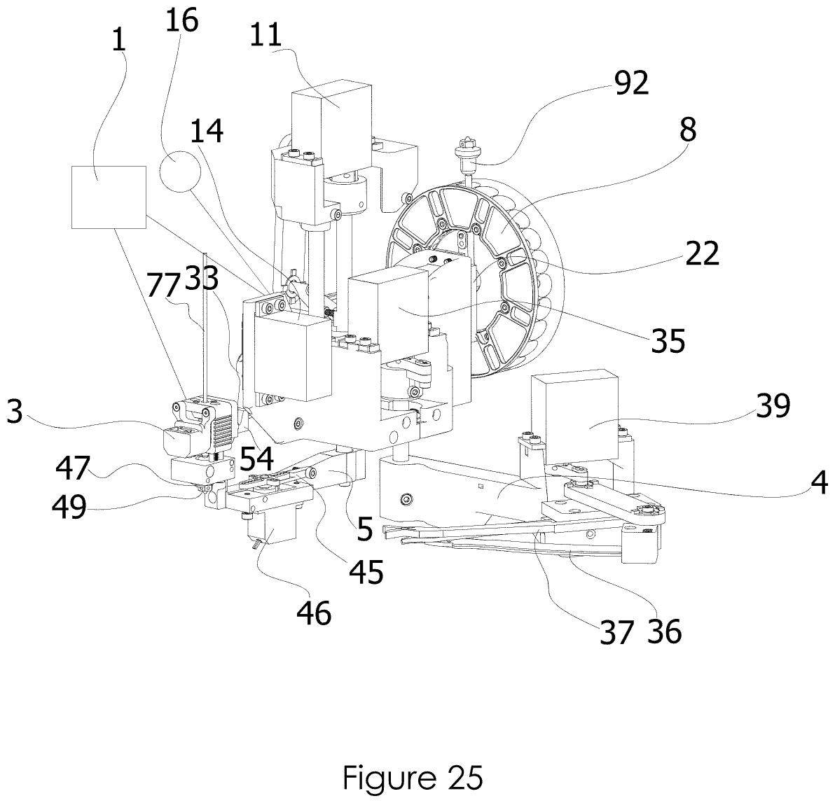

Then in FIG. 25, the actuation arm Z axis motor 13 raises the actuation arm Z axis arm 12, which raises the actuation arm rotating shaft motor 11, which raises the actuation arm rotation shaft 10, which raises the actuator arm 5, which raises the end effector 47 into contact with the core 49.

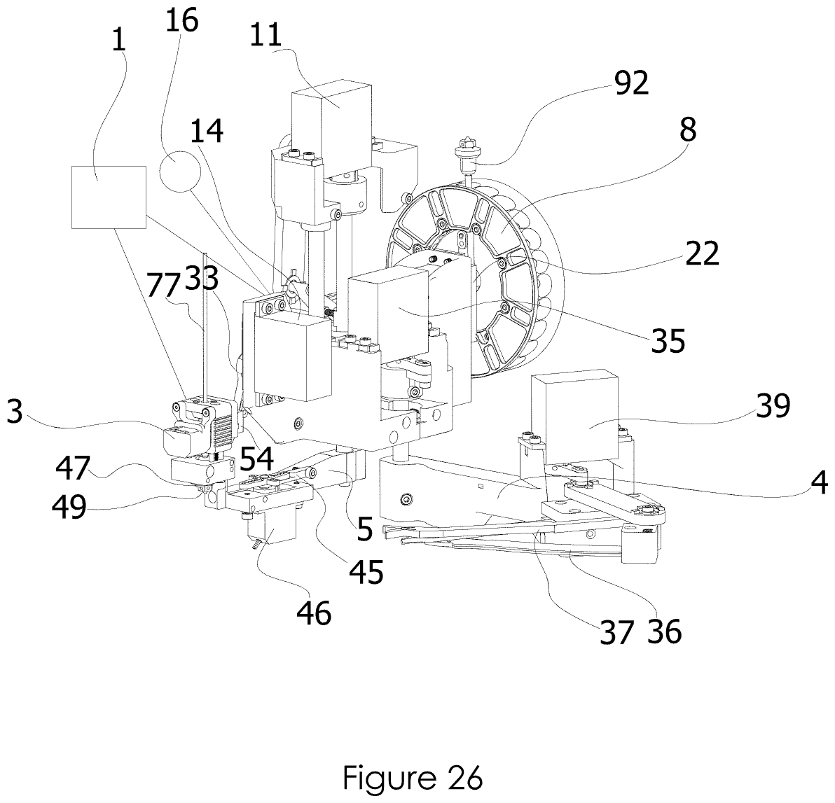

Then in FIG. 26, the coreless hotend lock motor 14 rotates the coreless hotend lock actuator 33, which presses against the core lock 54 unlocking the core 49 from the coreless hotend 3.

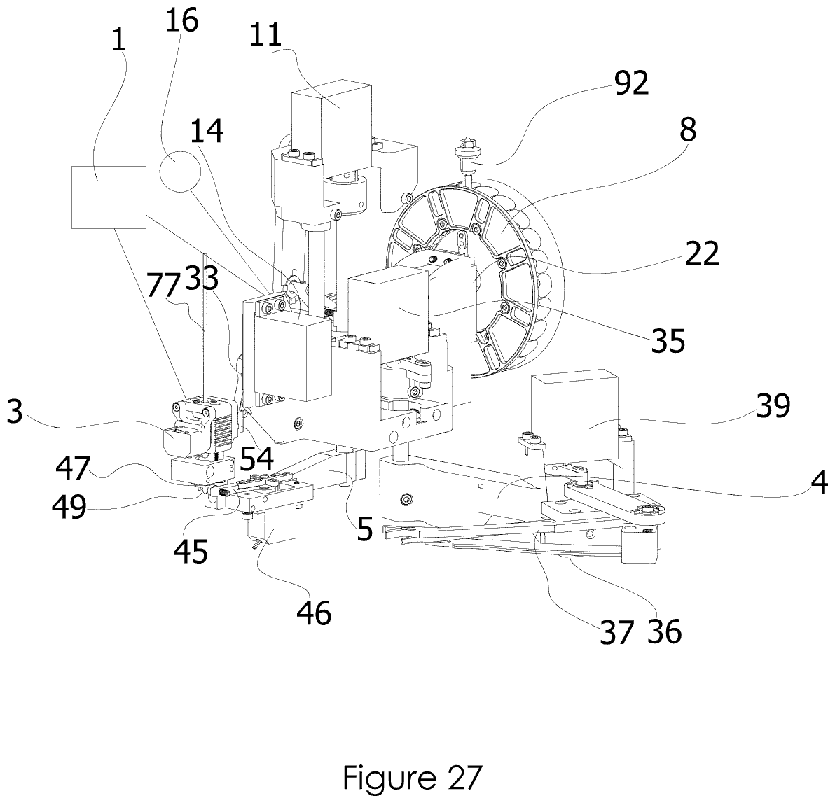

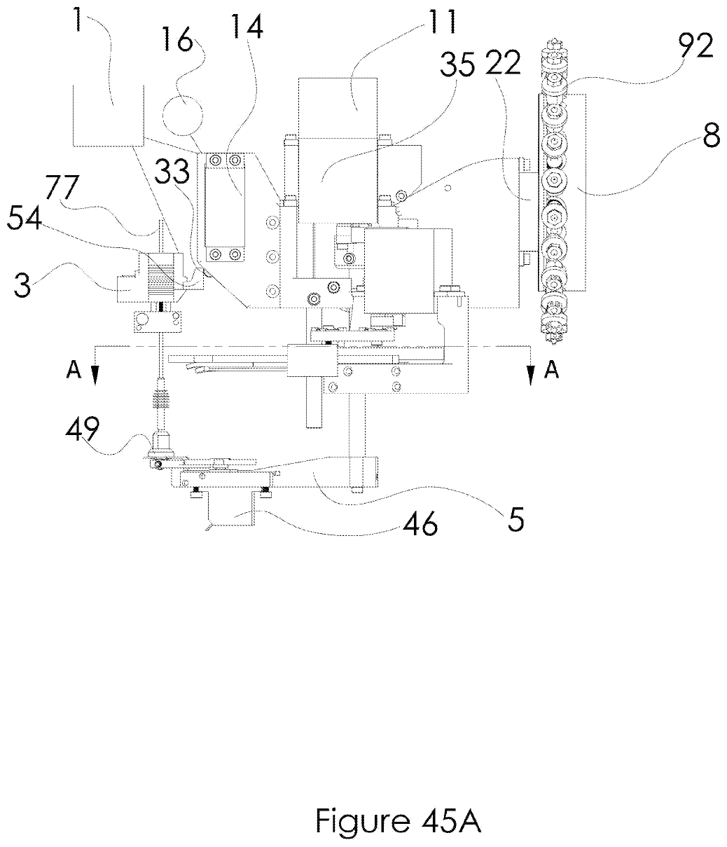

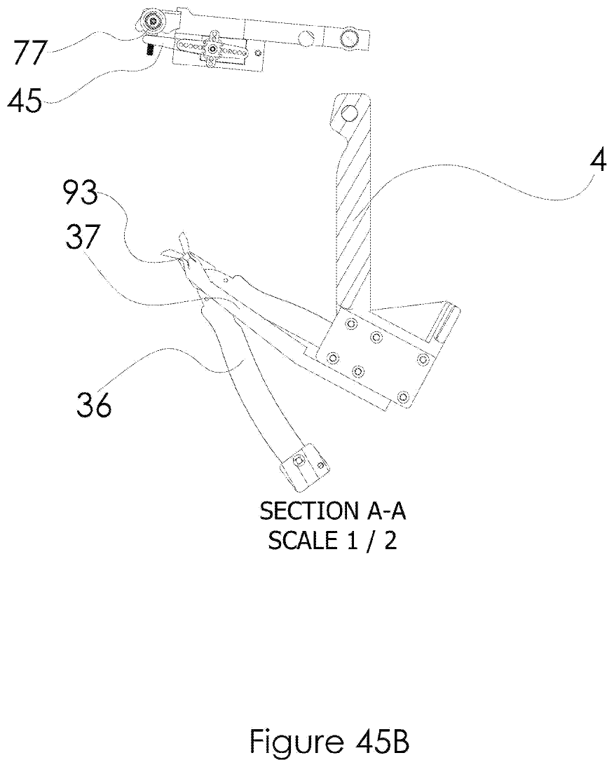

In FIG. 27, the actuation arm-core lock motor rotates the actuation arm-core lock 45, which secures the core 49 in the end effector 47 for the duration of the core exchange process. In FIG. 45, a top down view (Section A-A) shows the position of the actuation arm-core lock 45, which is in the locked position relative to the core 49.

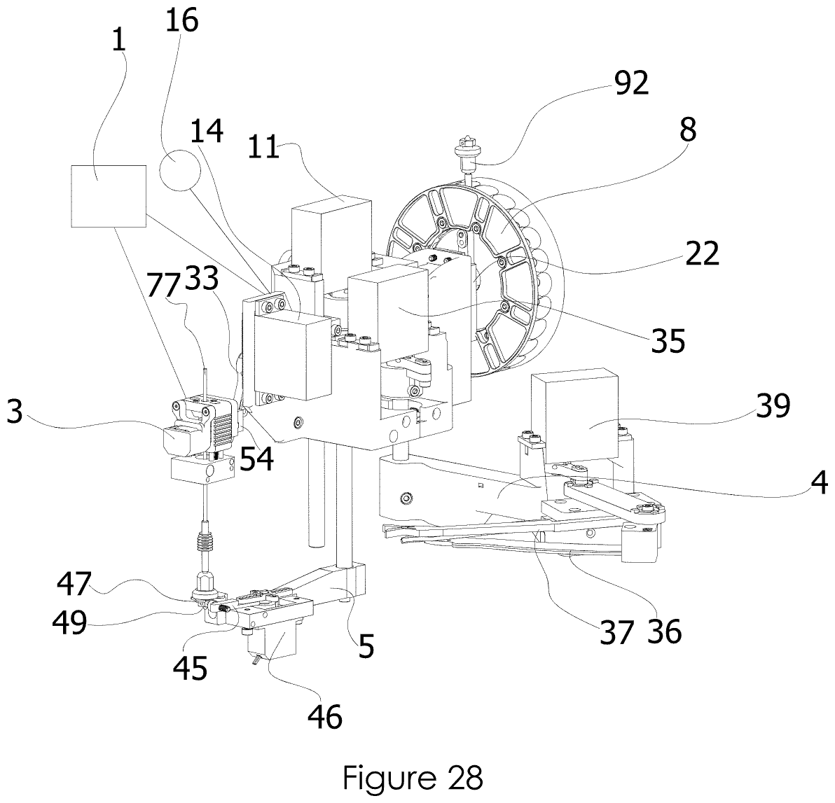

In FIG. 28, the core exchanger CNC controller 16 coordinates with the printer CNC controller 17 to synchronously move the filament 77 downward at the same rate as the end effector 47 moves the core 49 downwards, keeping the filament 77 inside the core 49. The core 49 is moved downwards exposing the filament 77 to the filament cutter blade 36.

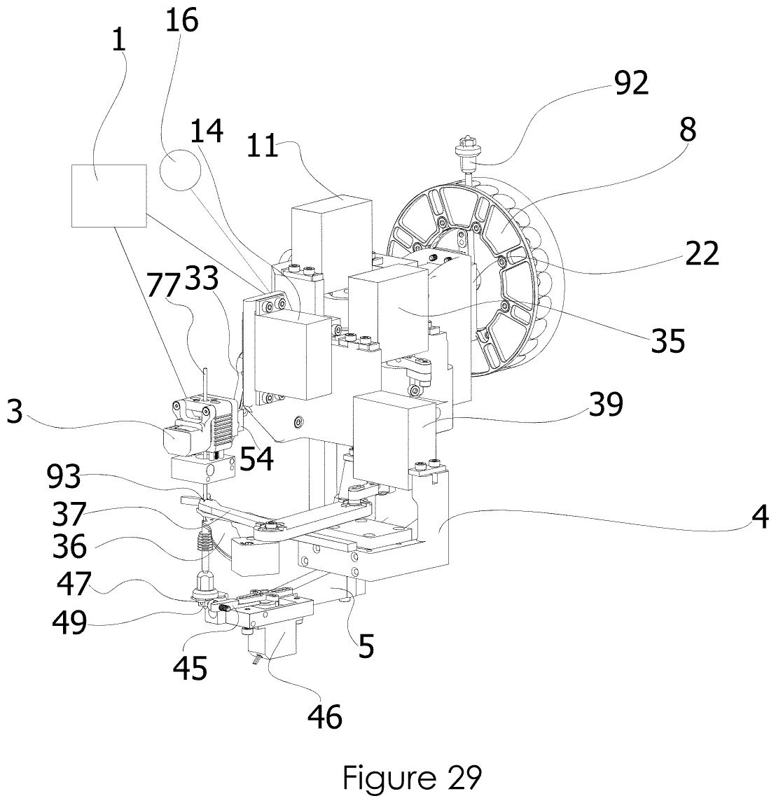

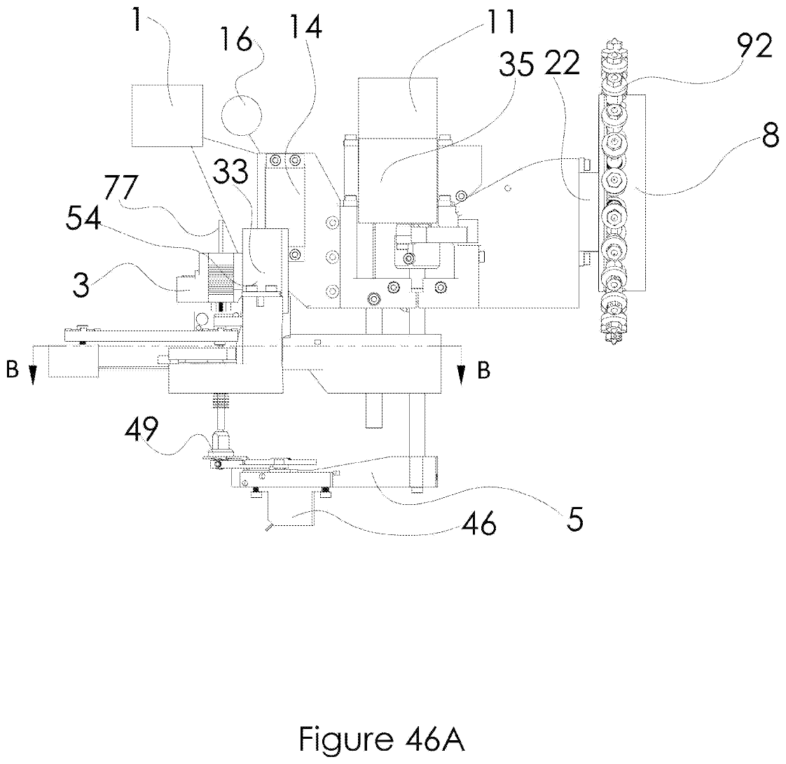

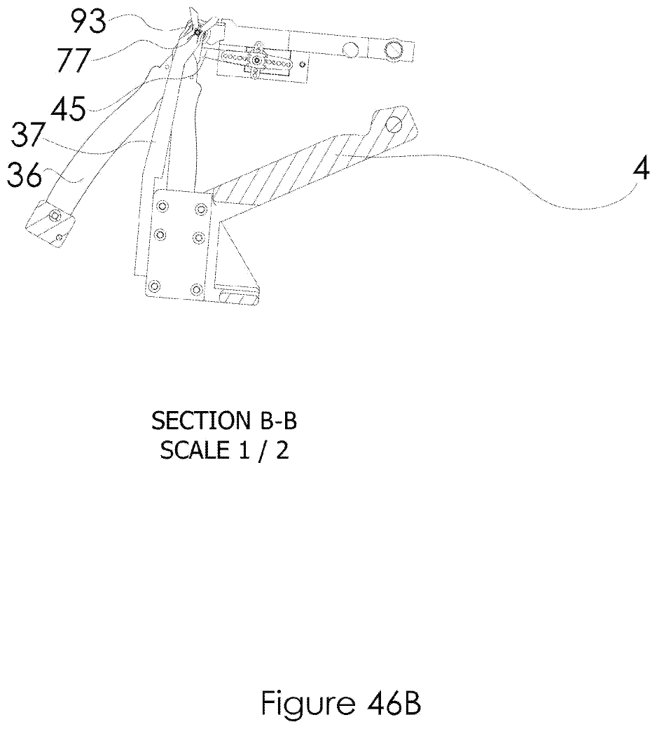

In FIG. 29, the filament cutter 4 is rotated into cutting position by the filament cutter rotation shaft 34 attached to the filament cutter rotation motor 35. The filament cutting guide alignment hole 93 of the filament cutting guide 37 secures to the filament 77 keeping the filament 77 aligned to the cutter blade. In FIG. 46, a top down view (Section A-A) of the filament cutting guide alignment hole 93 of the filament cutting guide 37 secured to the filament 77 and the position of the filament cutter blade 36 in filament 77 cutting position.

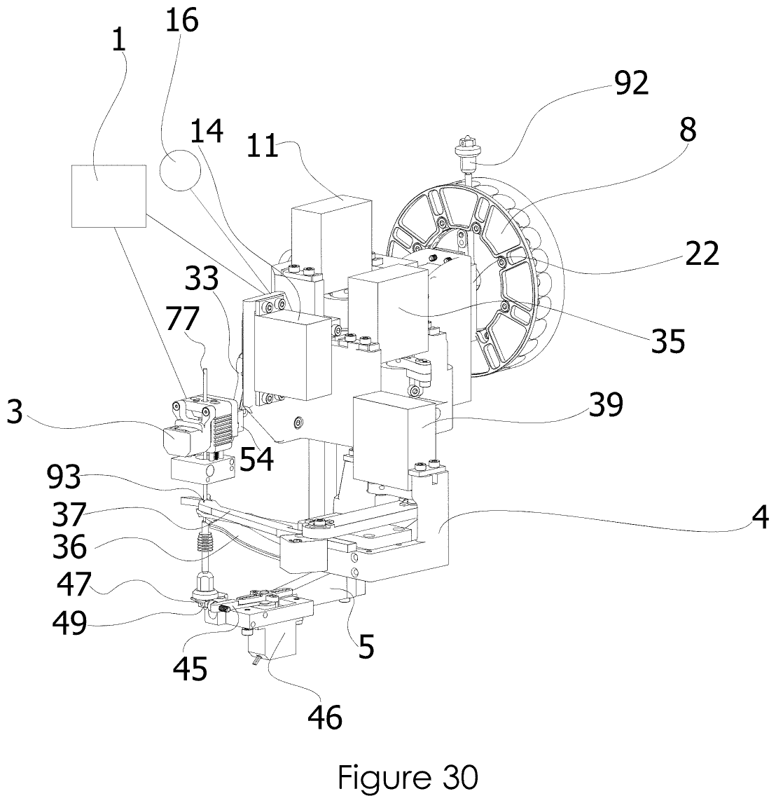

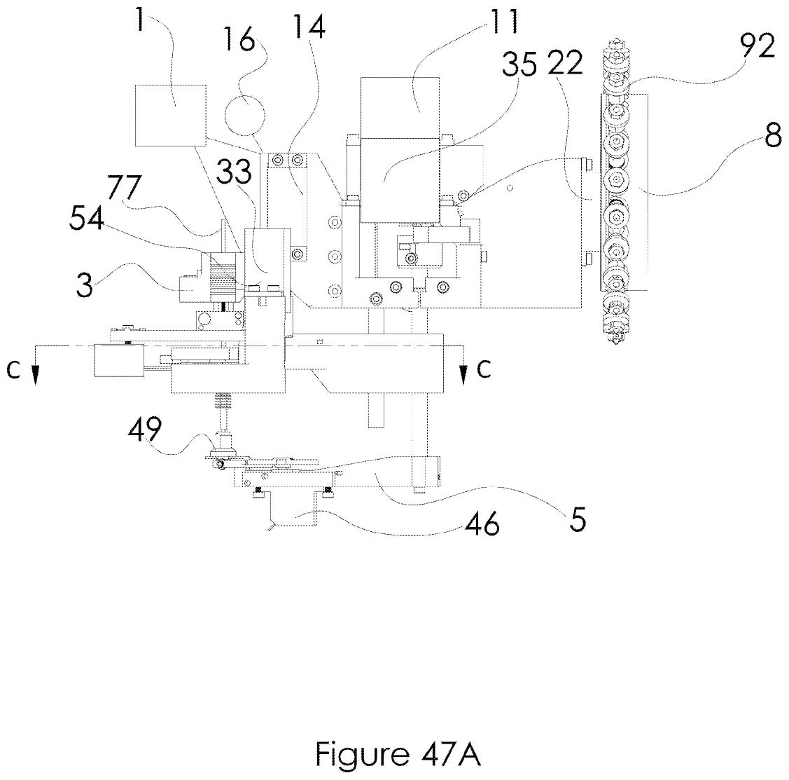

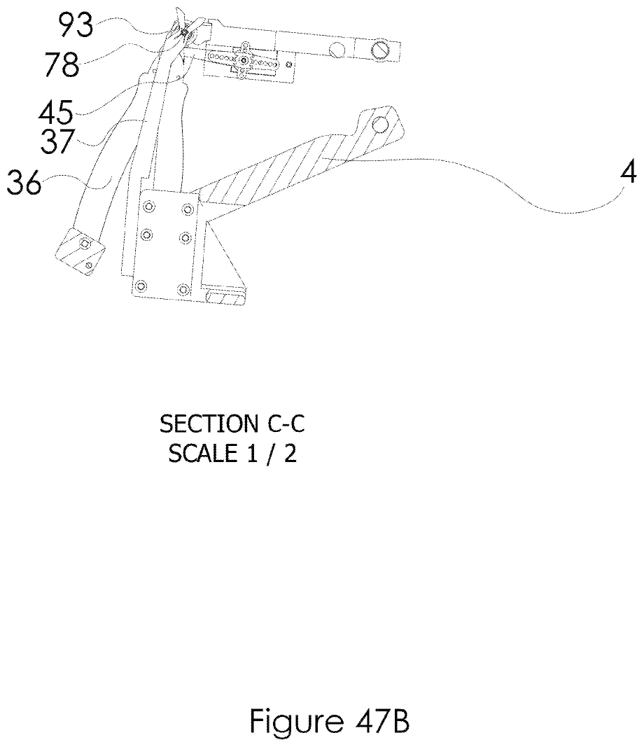

In FIG. 30, the filament cutter blade 36 is activated by the filament cutter actuation motor 39 to cut the filament 77 producing. In FIG. 47, a top down view (Section A-A) shows the filament cutter blade 36 in the cut position.

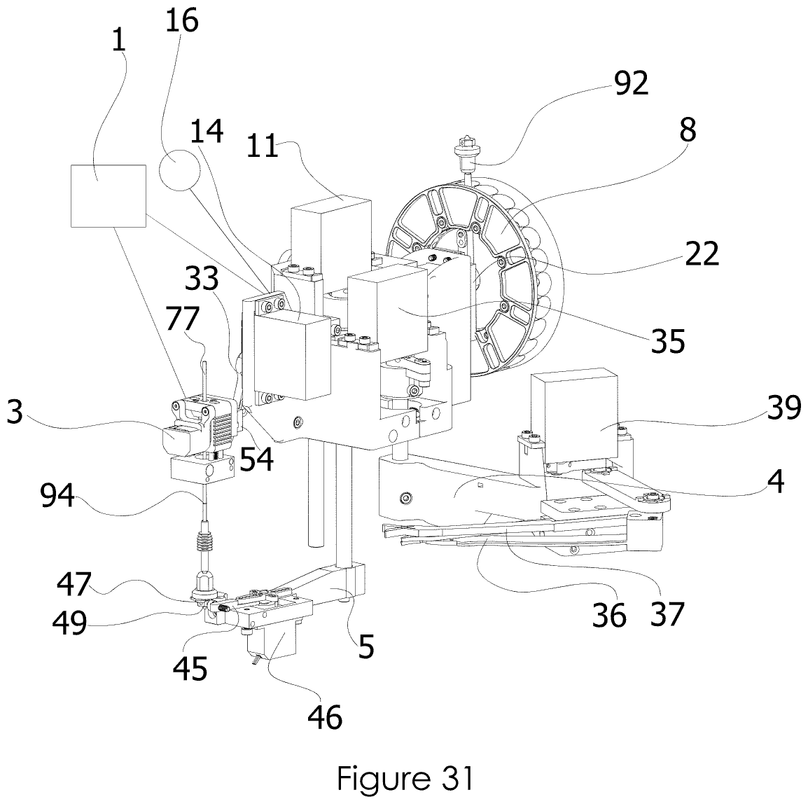

In FIG. 31, the filament cutter 4 is rotated back to its starting position by the filament cutter rotation shaft 34 attached to the filament cutter rotation motor 35 and exposing the filament cut 94.

In FIG. 9, the core storage mechanism 8 is rotated so that the secondary Core 92 is in alignment with the preheater-heater block 23.

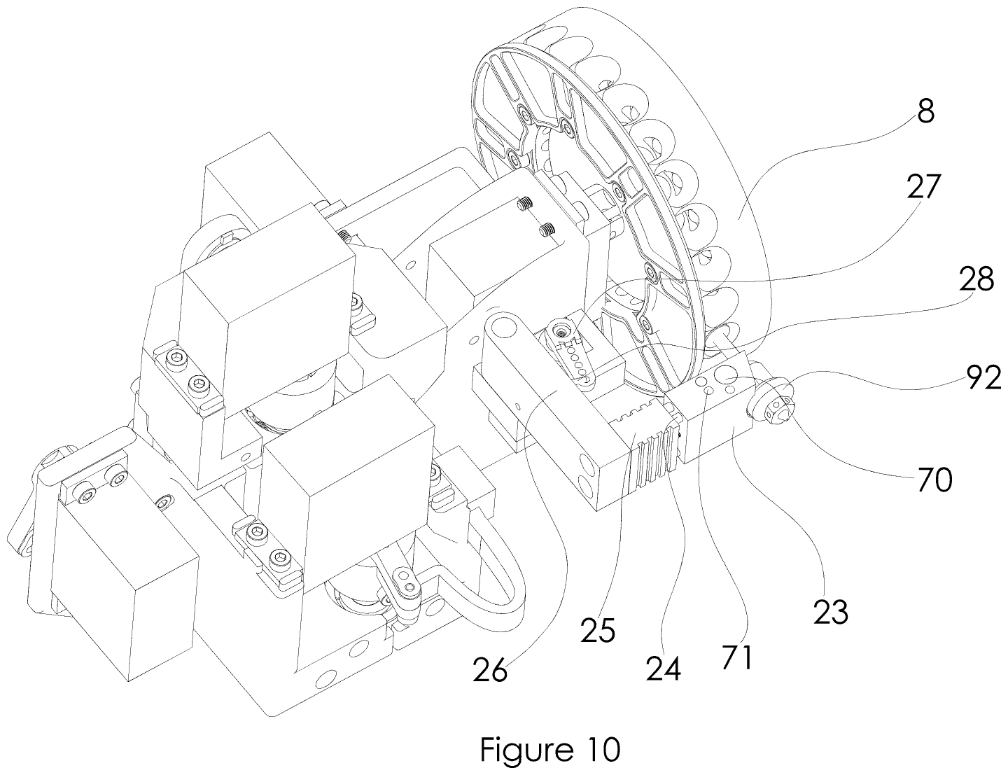

In FIG. 10, the preheater-rotation arm 26 is connected to the preheater-rotation motor 27 by the preheater-motor to arm connecting rod 28, the preheater-rotation arm 26 is rotated by preheater-rotation motor 27 so that the preheater-heater block 23 connects with the secondary core 92. The preheater-heater block is heated by the preheater-heating element 70 whose temperature is sensed by the preheater-temperature sensor 71 and is controlled by the core exchanger CNC controller 16. Once the secondary core 92 has reached the desired temperature, the preheater-heater block 23 is rotated away from the secondary core 92 as specifically shown in FIG. 9.

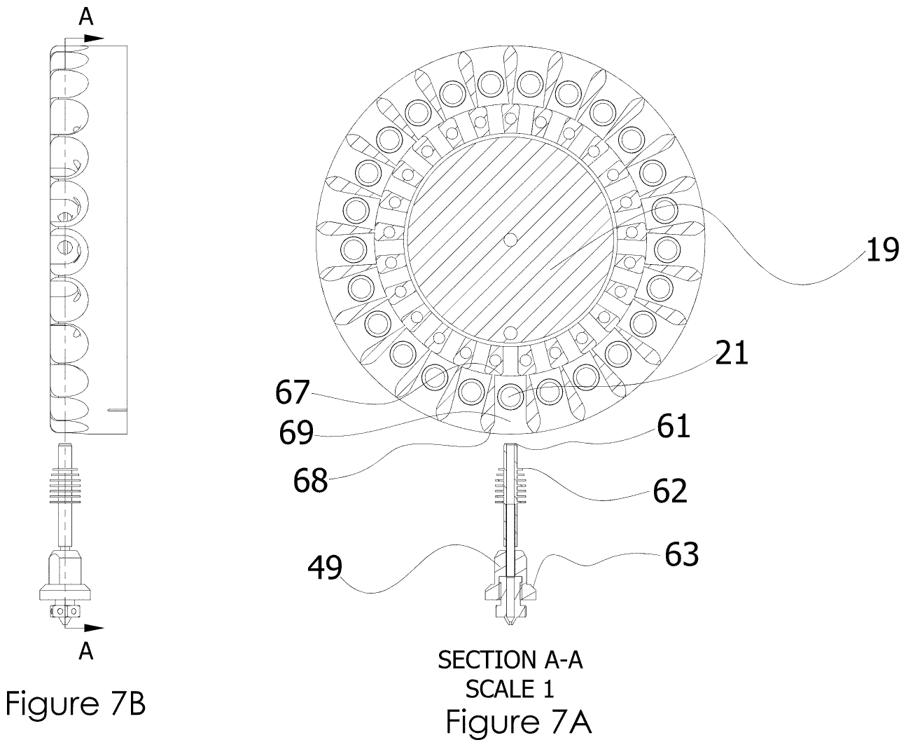

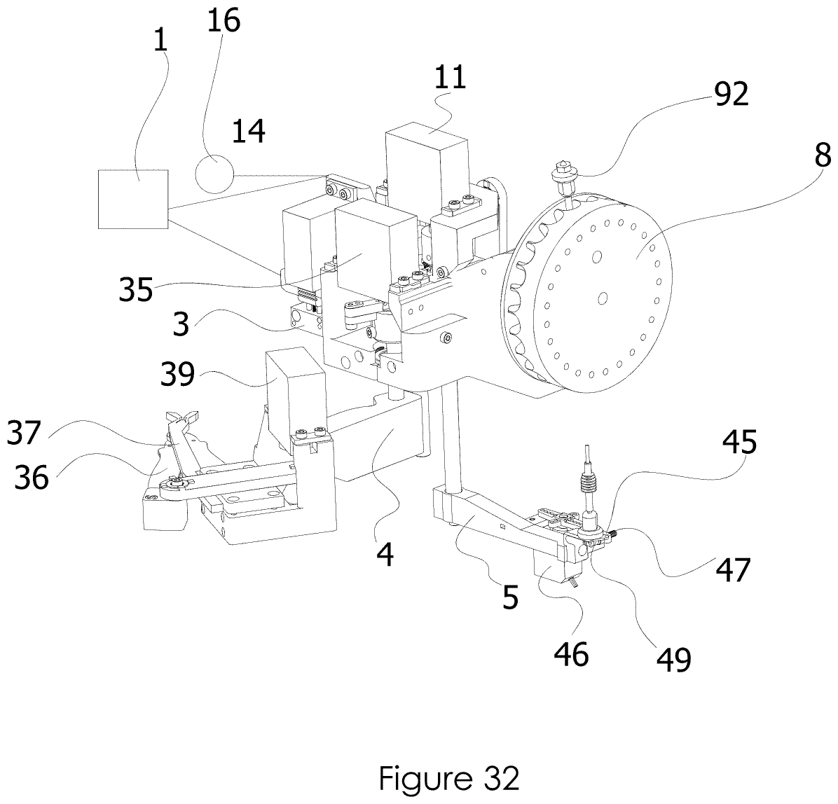

In FIG. 32, the actuation arm 5 is rotated by the actuation arm rotation shaft 10 and the actuation arm rotating shaft motor 11 to directly underneath the core storage mechanism 8. In FIG. 7, Section A-A, the unloaded core 49 is shown waiting below an empty core storage receptacle 69 of the core storage plunger base. The tip 61 or core 49 is centrally aligned with the core storage tip alignment guide 67, and the fin 62 of core 49 is centrally aligned with the core storage fin alignment guide 68. Once the core 49 is inserted into the core storage receptacle 69, the spring-loaded ball bearing plungers 21 will retain the core 49 by exerting spring loaded pressure against the fin 62.

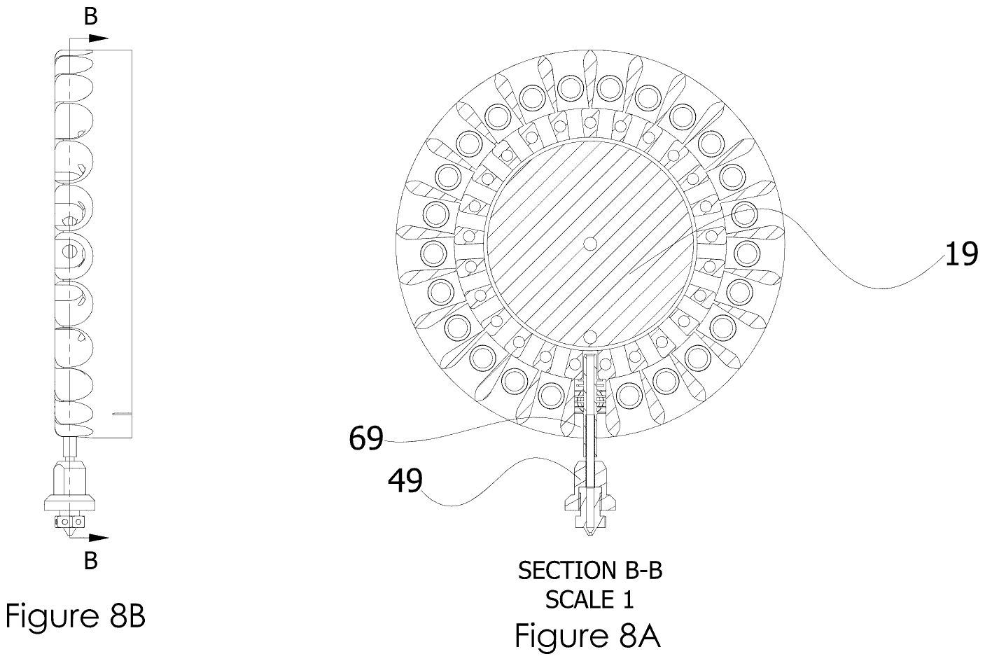

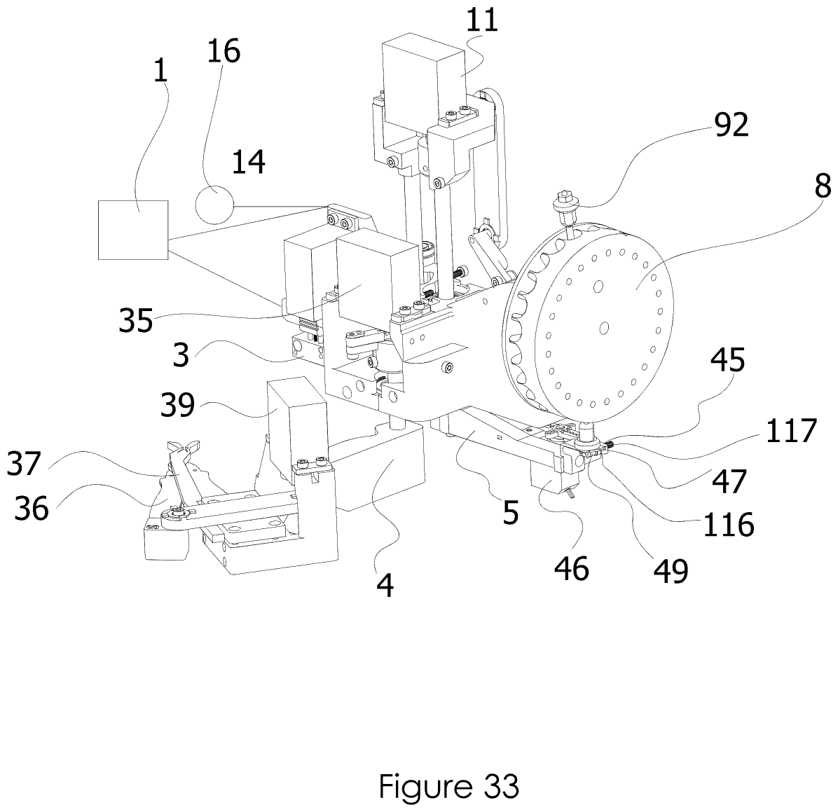

In FIG. 33, the actuation arm 5 raises the end effector 47, which causes the core Parallel surface 115 to mate with the end effector parallel surface 116, which raises the core 49 into the core storage mechanism 8. In FIG. 8 the core 49 is shown fully retained in the core storage receptacle 69 of the core storage plunger base 19.

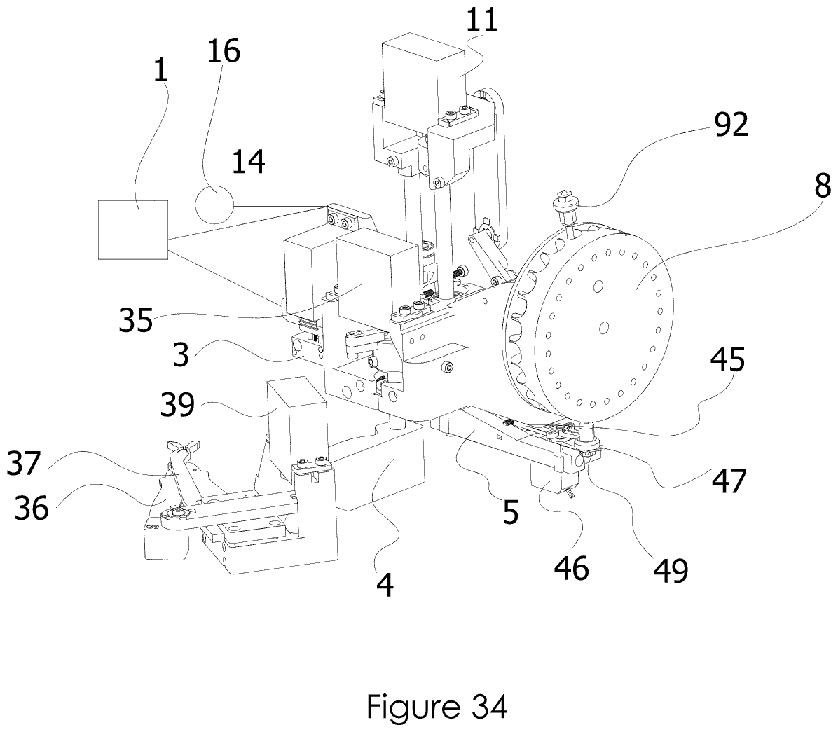

In FIG. 34, the actuation arm-core lock 45 is rotated by the actuation arm-core lock motor 46 away from the core 49.

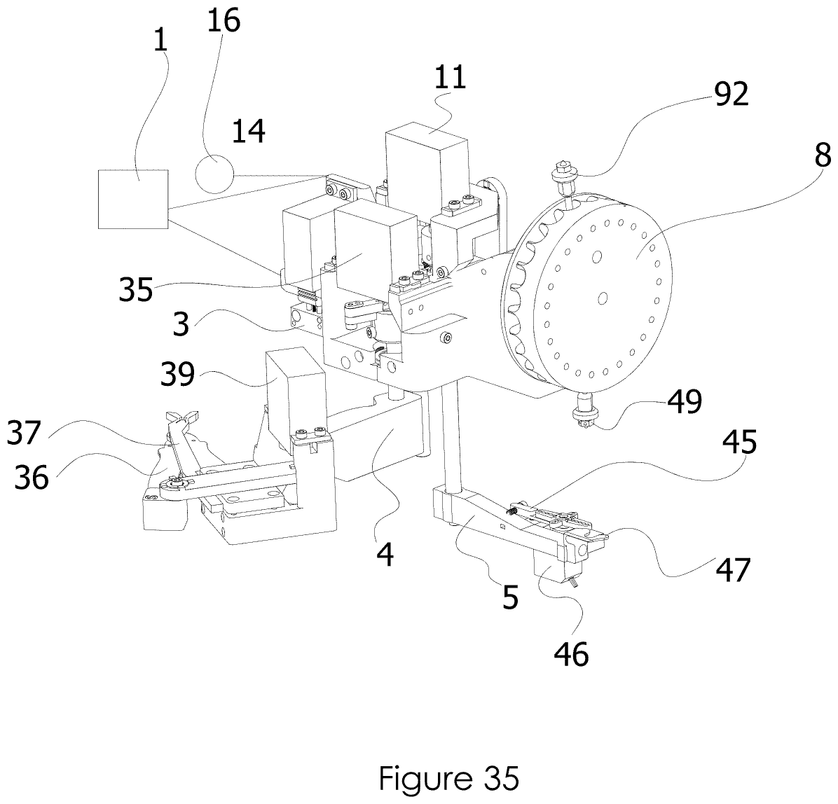

In FIG. 35, the actuation arm 5 lowers the empty end effector 47.

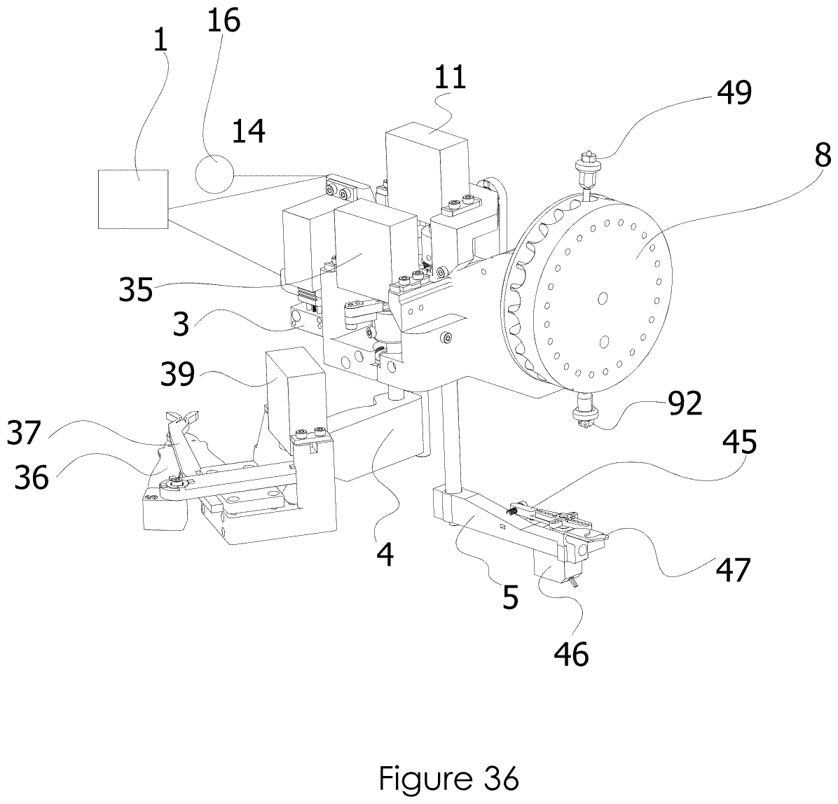

In FIG. 36, the core storage receptacle selector motor 7 rotates the core storage mechanism 8 to align the secondary core 92 centrally to the end effector 47.

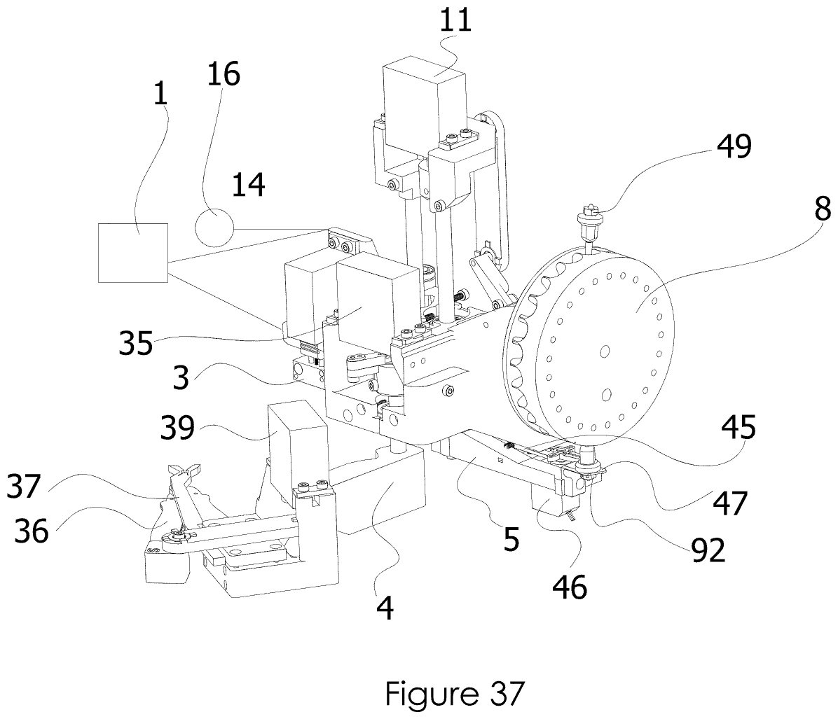

In FIG. 37, the actuator arm 5 raises the end effector 47 to engage with the secondary core 92.

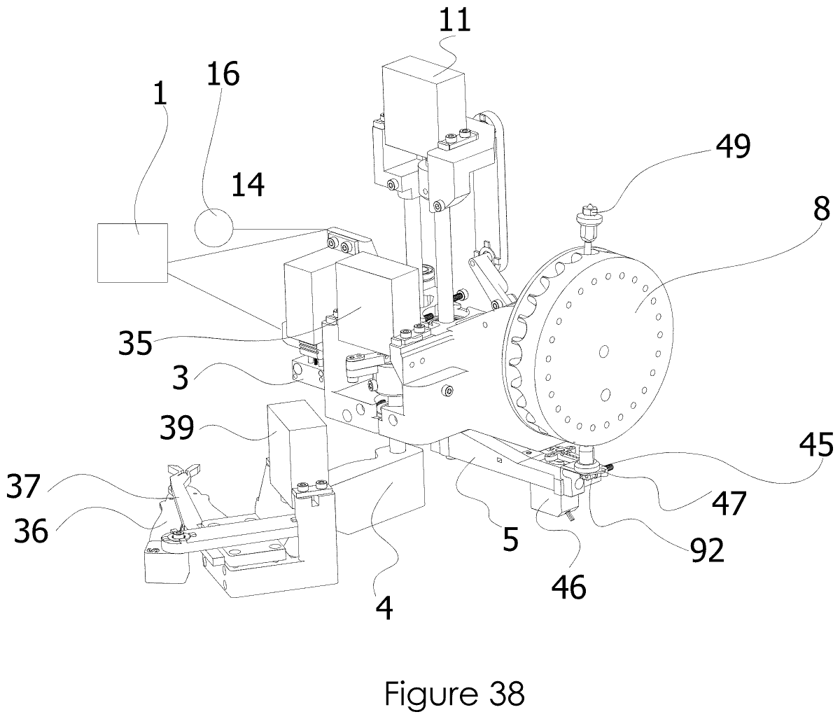

In FIG. 38, the actuation arm-core lock is rotated by the actuation arm-core lock motor 46 to secure the secondary core 92 in the end effector 47.

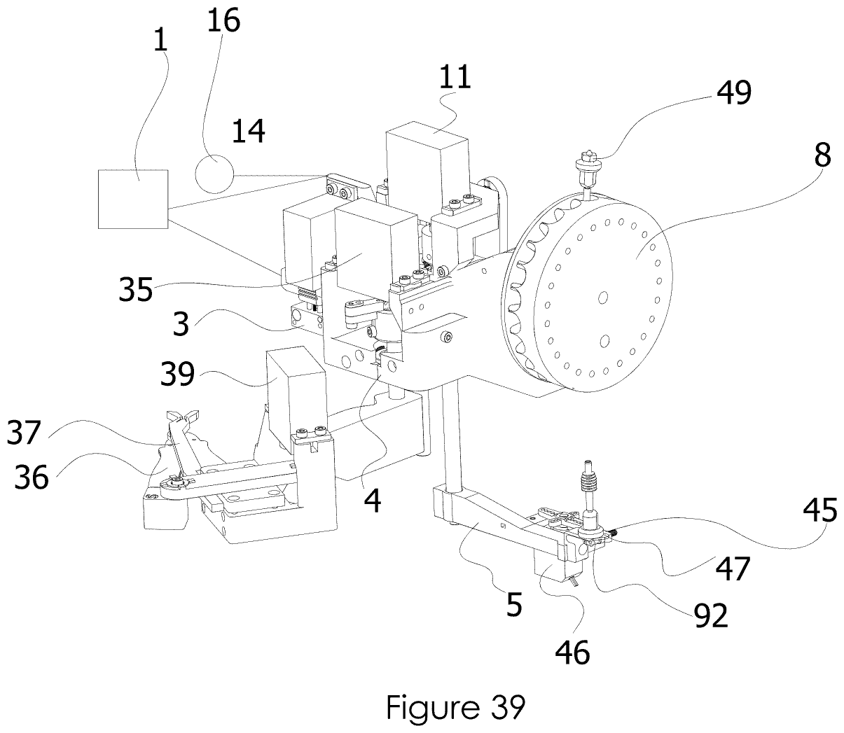

In FIG. 39, the actuation arm 5 lowers the end effector 47 and the secondary core 92 is withdrawn from the core storage mechanism 8.

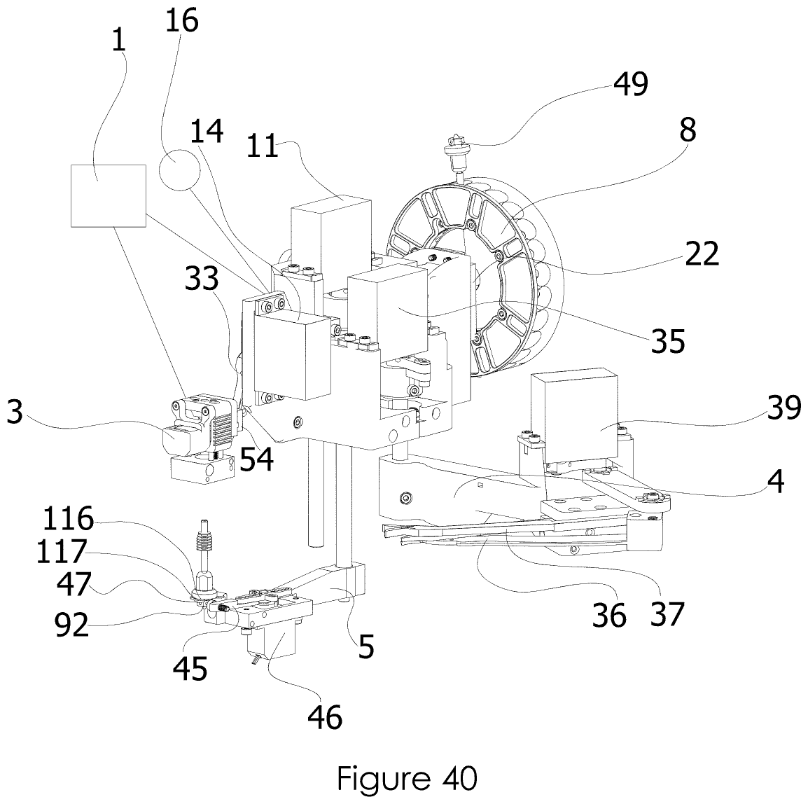

In FIG. 40, the core parallel surface 115 mates with the end effector parallel surface 116, and the secondary core 92 is moved into position centrally aligned with the coreless hotend 3 by the actuation arm rotating shaft motor 11.

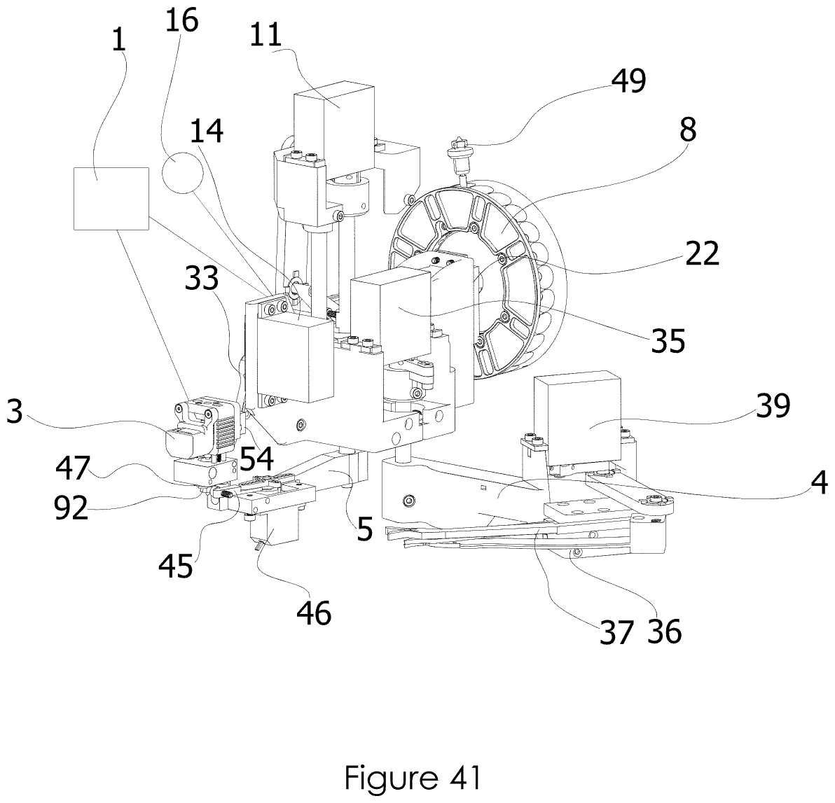

In FIG. 41, the actuating arm 5 raises the end effector 47 up, which presses the secondary core 92 into the coreless hotend 3.

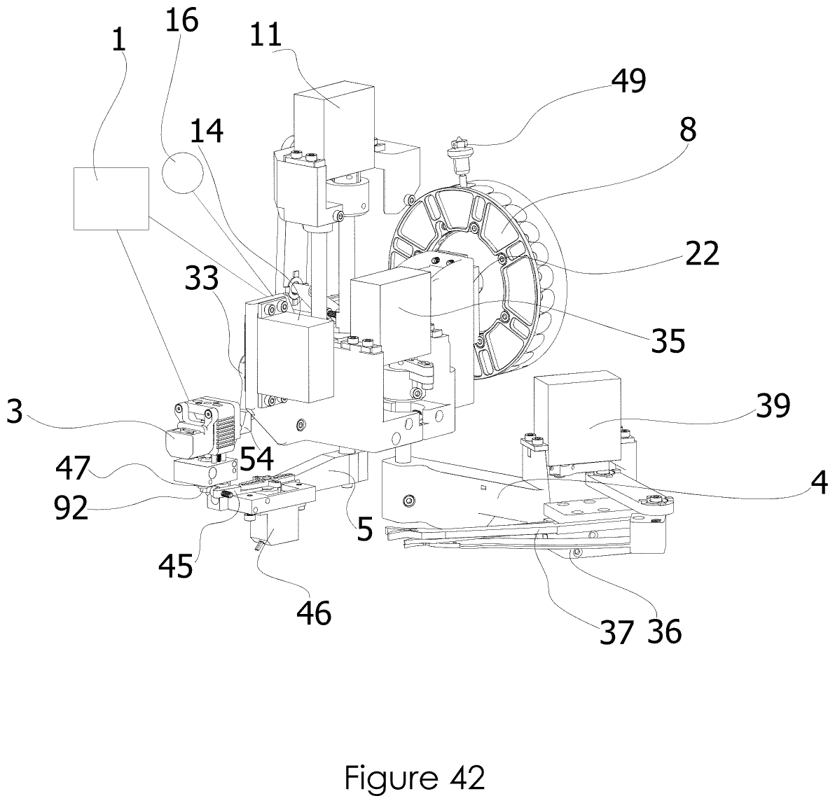

In FIG. 42, the coreless hotend lock motor 14 rotates the coreless hotend lock actuator 33 locking the Secondary core 92 into the coreless hotend 3.

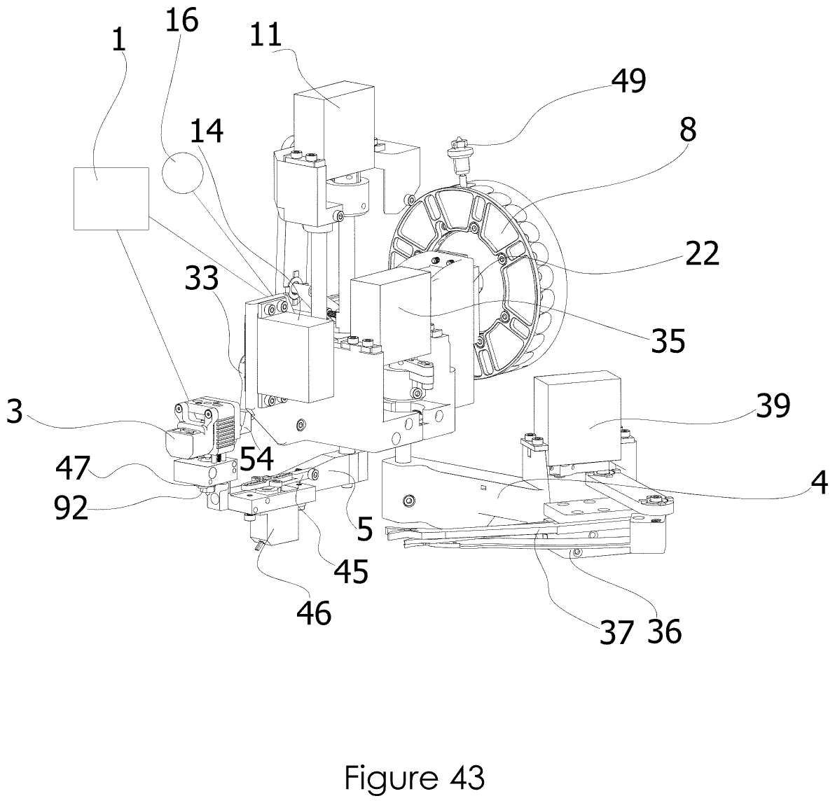

In FIG. 43, the actuation arm-core lock 45 is rotated away from the secondary core 92 by the actuation arm-core lock motor 46.

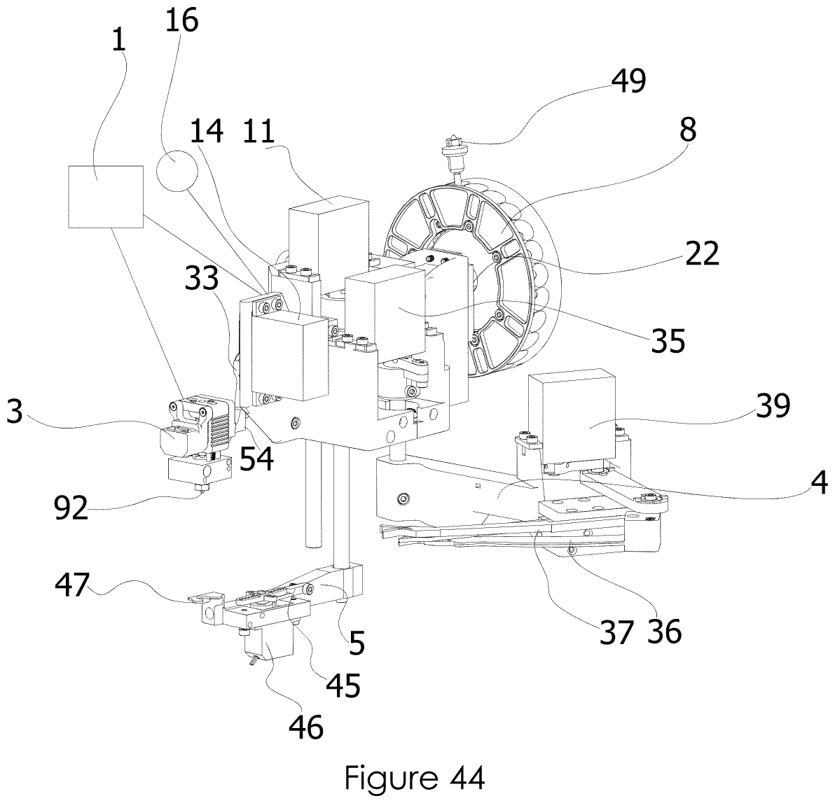

In FIG. 44, the end effector 47 and connected actuation arm 5 is lowered away from the secondary core 92 and the now the core exchanger CNC controller 16 signals to the 3D printer 1 that it may can continue to print as normal.

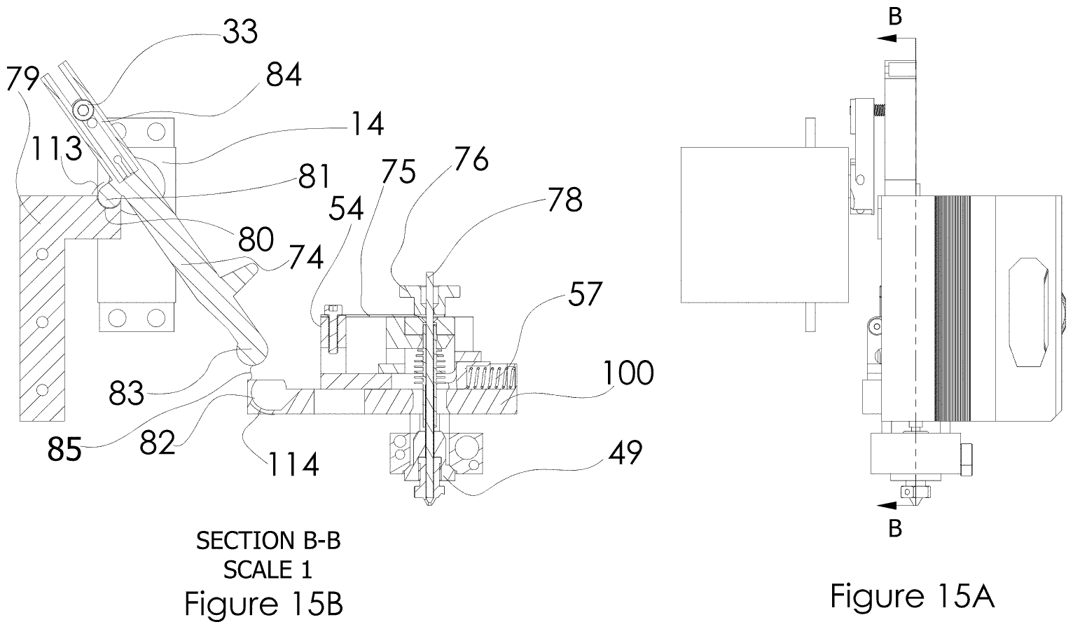

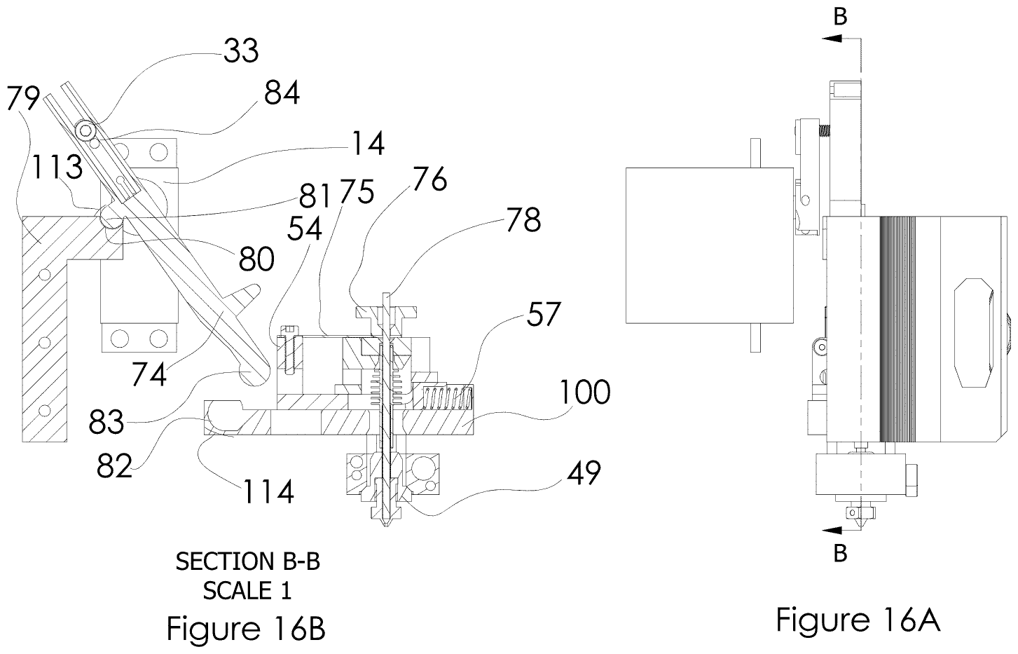

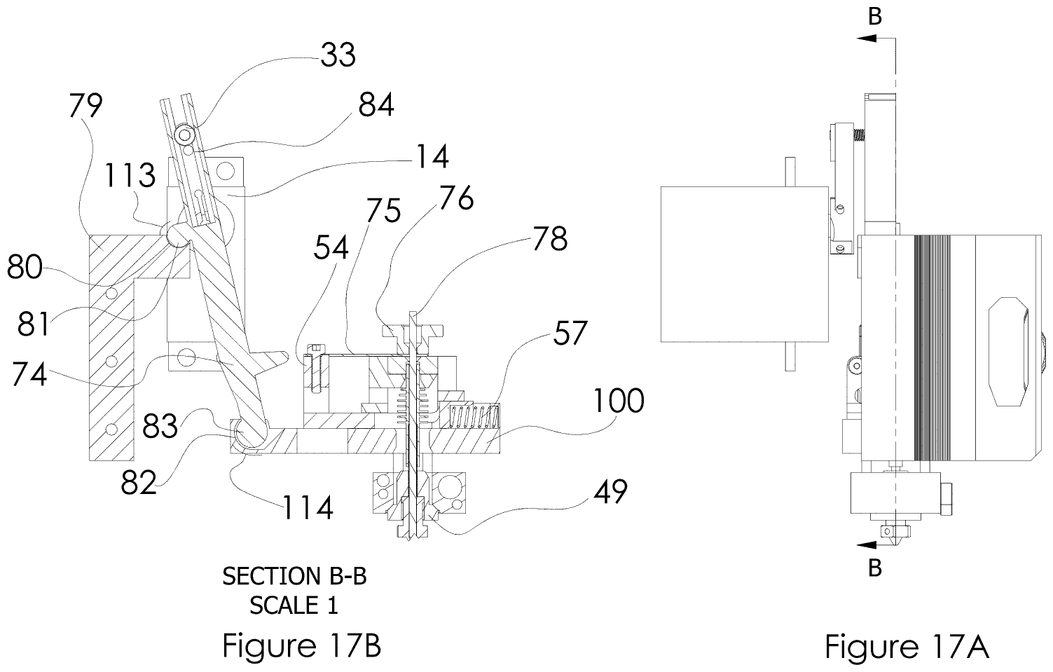

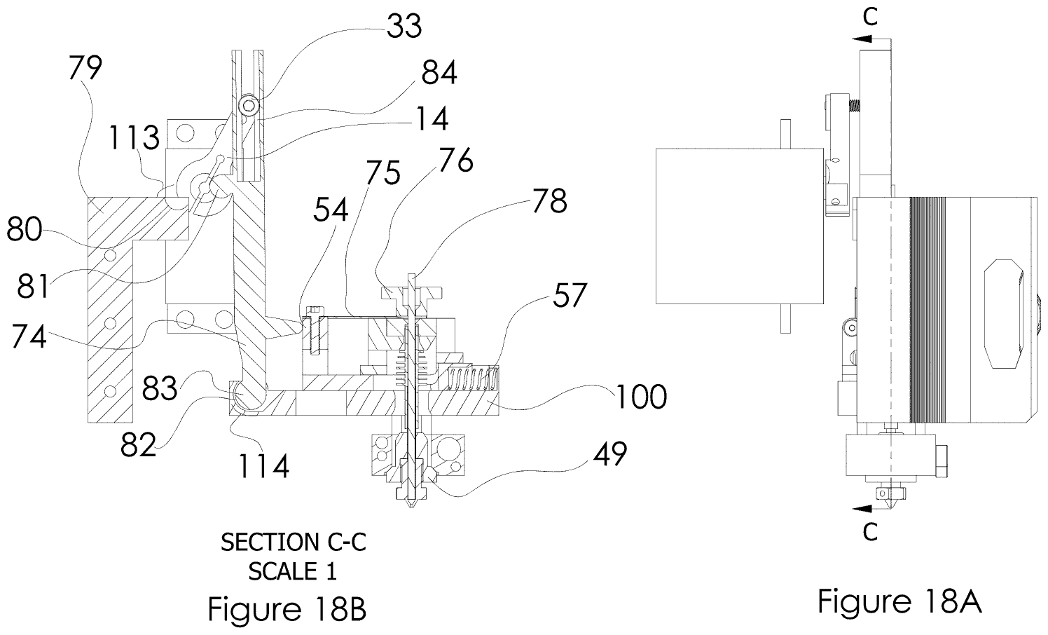

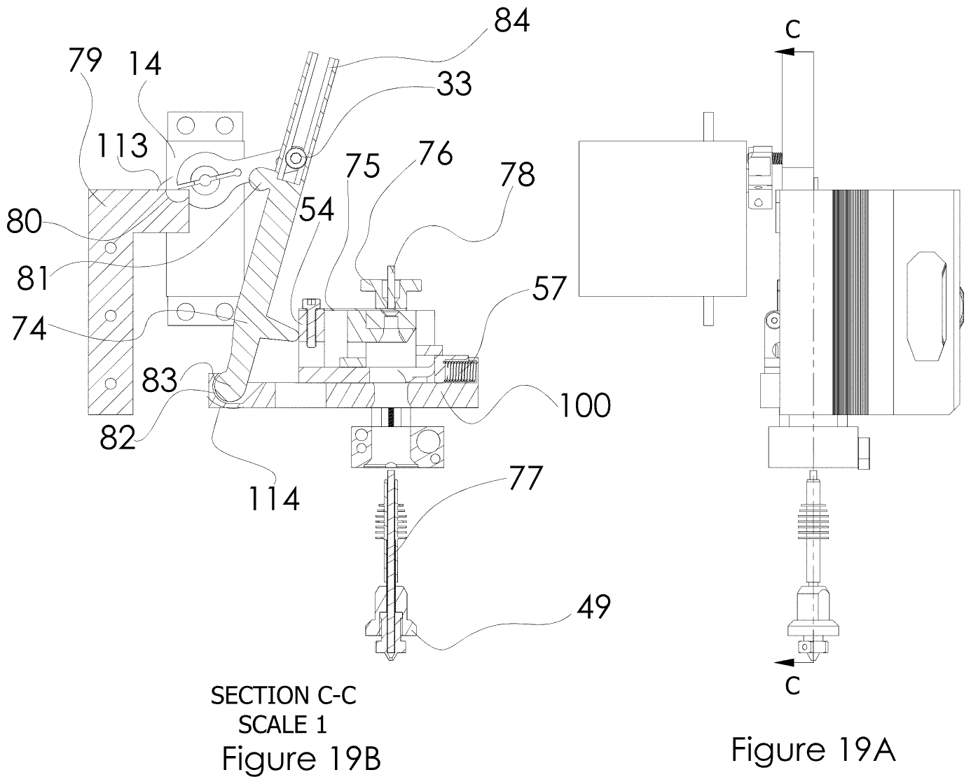

With reference to FIGS. 14A to 19B, an alternative cutting mechanism, the disconnected cutter, is shown. The coreless hotend with disconnected cutter is a substitute for the coreless hotend 3 and filament cutter 4 shown in FIG. 1. Indeed, the coreless hotend with disconnected cutter functions in the core exchanger system 15 of FIG. 1 as follows. In FIGS. 14A and 14B, the cutting lever 74 is in its default waiting state, with the first pivot 81 connected with the first pocket 80 and creating fulcrum one 113, and the second pivot 83 and second pocket 82 disconnected from each other, and the coreless hotend lock actuator 33 in the fully upright primary position, and the core 49 fully inserted and engaged with the uncut filament 77. In FIGS. 15A and 15B, the coreless hotend lock motor 14 rotates counter clockwise and the coreless hotend lock actuator 33 slides in the horn channel 84, causing the cutting lever 74 to pivot around first pocket 80 and swing away from the core exchanger to printer mounting bracket 79 and move second pivot 83 towards second pocket 82, thereby creating clearance 85. In FIGS. 16A and 16B, the coreless hotend with disconnected cutter 100 moves to the left causing second pocket 82 to move past second pivot 83. In FIGS. 17A and 17B, the coreless hotend lock motor 14 rotates clockwise and the coreless hotend lock actuator 33 slides in the horn channel 84 causing the cutting lever 74 to pivot around first pocket 80 and cause second pivot 83 to connect with second pocket 82 creating fulcrum two 114. In FIGS. 18A and 18B, the coreless hotend lock motor 14 continues to rotate clockwise and the coreless hotend lock actuator 33 slides in the horn channel 84 causing first pivot 81 to disengage with first pocket 80 and engage with the core lock 54. In FIGS. 19A and 19B, the coreless hotend lock motor 14 continues to rotate clockwise and the coreless hotend lock actuator 33 slides in the horn channel 84 full depressing the cutting lever 74 and causing the blade 75, which is guided by the blade guide 76, to cut the filament 77, separating it from the cut filament 78. At the same time, the core lock 54 slides fully to the right, unlocking the core 49, which is shown withdrawn from the coreless hotend with disconnected cutter 100.

With reference to FIGS. 11A to 12B, an alternative cutting mechanism, the integrated cutter, is shown. The coreless hotend with integrated cutter is a substitute for the coreless hotend 3 and filament Cutter 4 as shown in FIG. 1. Indeed, the coreless hotend with integrated cutter functions in the core exchanger system 15 of FIG. 1 as follows. In FIGS. 11A and 11B, the coreless hotend with integrated cutter 101 is in its default state with the coreless hotend lock actuator 33 in the fully upright position and the core lock 54 engaged with the spring 57 to keep it in the locked position, and the core 49 locked in place and engaged with the uncut filament 77. In FIGS. 12A and 12B, the coreless hotend lock actuator 33 is rotated clockwise by the coreless hotend lock motor 14 causing the cutting lever 74 to press the core lock 54 and fully compress the spring 57, and sliding the blade to the right, which is guided by the blade guide 76 to fully cut the filament 77, leaving a cut Filament 78 and allowing the core 49 to be fully withdrawn out of the coreless hotend with integrated cutter 101.

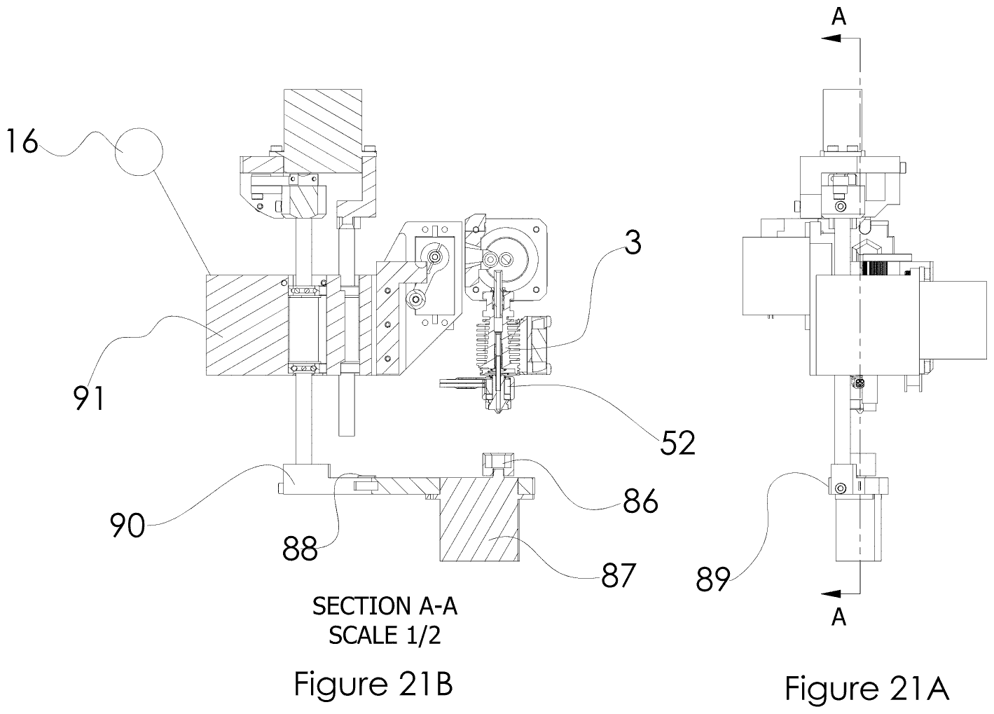

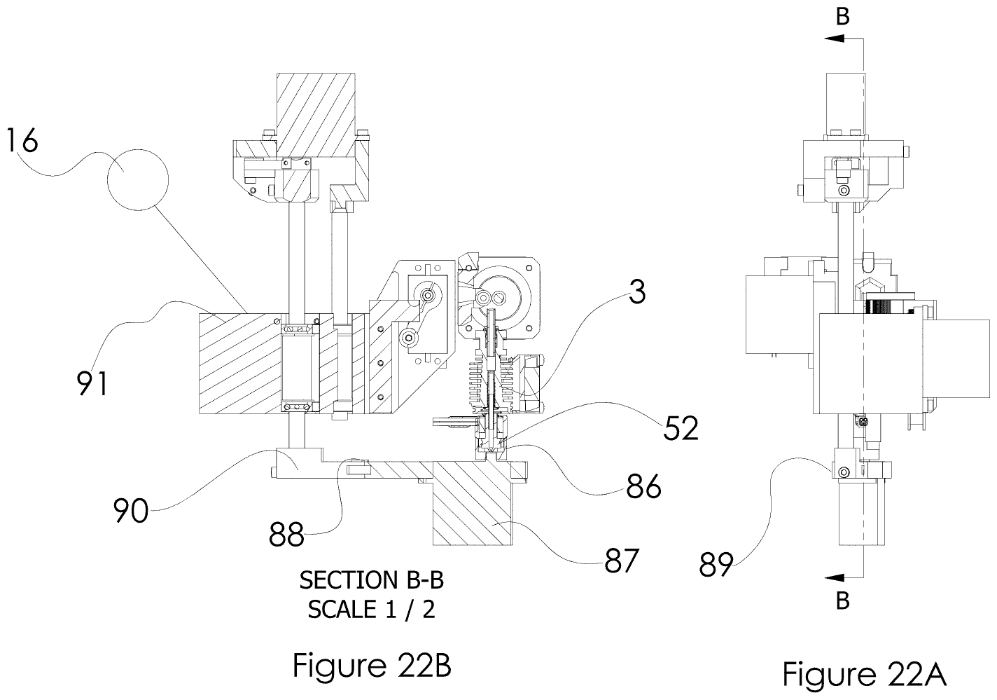

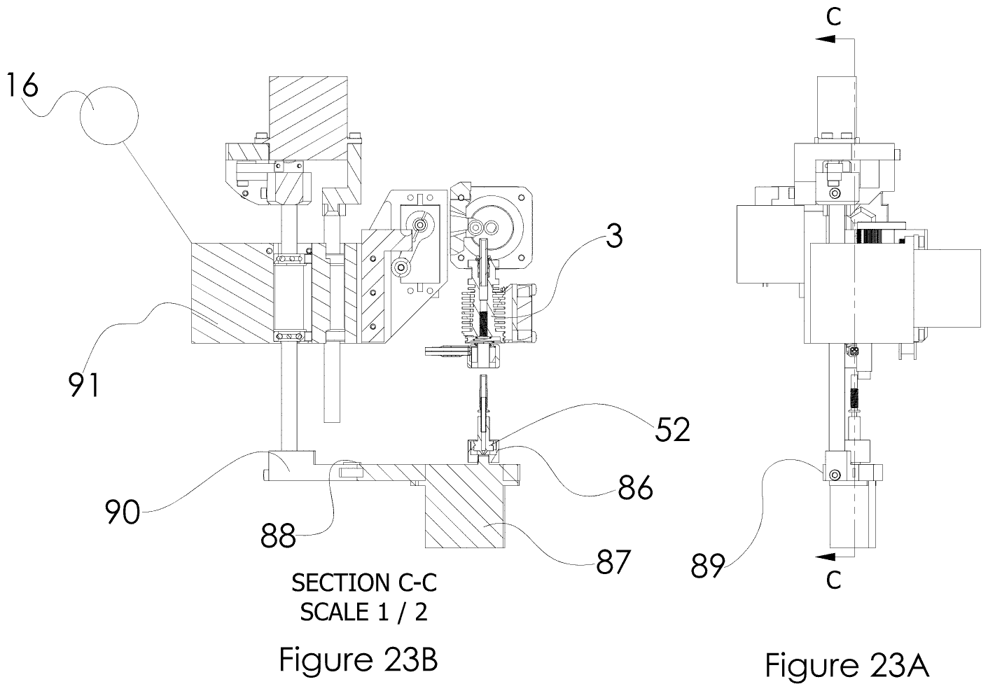

With reference to FIGS. 21A to 23B, an alternative core actuation is shown. The nozzle unscrewing mechanism 91 is an alternative embodiment of the core actuation arm 5 shown in FIG. 1. Indeed, the nozzle unscrewing mechanism 91 functions in the core exchanger system 15 of FIG. 1 as follows. In FIGS. 21A and 21B, the state interjected at the step of FIG. 24, the nozzle unscrewing mechanism 91 is shown during a 3D print during a color change with the socket 86 positioned directly under the nozzle 52. In FIGS. 22A and 22B, the unscrewing arm 90 is raised up and engaged with the nozzle 52, which is unscrewed by the counter clockwise rotation of the socket motor 87. As the socket motor 87 rotates, a rotational force is sensed by the first sensor, which allows the core exchanger CNC controller 16 to sense if the torque of the process is correct, and as the threads of the nozzle create a downward force on the unscrewing arm 90, the second sensor detects and communicates this force to the core exchanger CNC controller 16, which lowers the unscrewing arm 90 at the same rate. In FIGS. 23A and 23B, the unscrewing arm 90 is now in its fully lowered position with the nozzle 52 fully withdrawn and disconnected from the coreless hotend 3. The first sensor 88 has detected that zero rotational torque is applied, and second sensor 89 detects no downward force, and this force information was communicated to the core exchanger CNC controller 16, which signaled the stop of the socket 86 rotation and the unscrewing arm downward travel. The process can now continue with the next step of FIG. 29 having skipped the steps shown in FIGS. 25 to 28.

In an alternate embodiment, the nozzle unscrewer could be modified to stand alone in a 3D printing system where the nozzle unscrewer mechanism with statically fixed to a 3D printer and the linear motion of the 3D printer would substitute for the Core exchanger motors, without departing from the scope of the present disclosure.

With reference to FIGS. 3, 13A and 13B, the exchangeable core 49 is shown. The core 49 is comprised of cooling fins 50, core heatbreak 51, core locking surface 72, core tapered mating surface 53, and nozzle 52. The cooling fins 50 are connected to the core heatbreak 51, which is in turn connected to the core tapered mating surface 53, which is connected to the nozzle 52. The connections between each of the components are thermally conductive. The core tapered mating surface 53 and the nozzle 52 and the cooling fins 50 are comprised of a very high thermally conductive material like copper or aluminum, while the core heatbreak 51 is comprised of a very low thermally conductive material like stainless steel in a preparation that is also very low thermal conductivity like that of a thin-walled surgical tube. The purpose of these material and configurations is to create a thermal barrier between the core tapered mating surface 53 as the hot side and the cooling fins 50 as the cold side. The surface of the core tapered mating surface 53 being tapered to center the core in the coreless hotend and provide a consistent seat for positioning between cores, and provide the greatest mating surface so that the heat from the coreless heater block can transfer to the currently installed core with the highest heat transfer and lowest thermal response time. The core locking surface mates with the core lock locking surface, which forms a ramp and when the spring 57 moves the core lock it connects the two surfaces together locking the core 49 into the coreless hotend 3. The core parallel surface 115 mates with the end effector parallel surface 116 during loading and unloading of the core into the coreless hotend or the core storage mechanism. The purpose of these parallel surfaces is to help concentrically align to the core receptacle 112. In the preferred embodiment of the core exchange system 15 of FIG. 1, the core 49 is moved between the coreless hotend 3 as the first position and the core storage mechanism 8 as the second position as effected by the motion of an actuator arm 5 with only a single position to hold a single core.

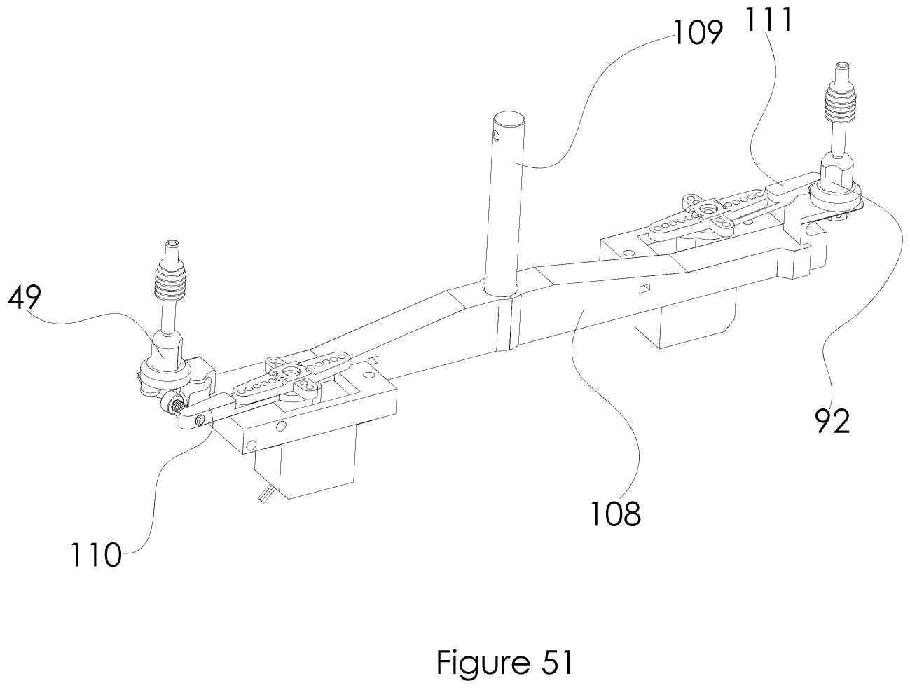

With reference to FIG. 51 and according to an alternate embodiment of the present disclosure. A multi core exchanging arm 108 can be provided to exchange more than one core simultaneously. During core exchanges the core lock one 110 retains the core 49 and core lock two retains the secondary core 92. The motion of the multi core exchanging arm 108 is controlled by the multi core exchanging actuation shaft 109. Because the multi core exchanging arm 108 can hold more than one core, it can also be used to store inactive cores in place of a separate core storage mechanism 8. To do so, it would insert the primary core 49 into the coreless hotend 3 and hold the secondary core 92 when printing is resumed, then when the secondary core 92 is needed, it would exchange the primary core 49 with the secondary core 92 and hold the primary core 49 while printing is resumed. Someone skilled in the art would understand that the capacity of the multi core exchanging arm 108 could be expanded to hold a plurality of hotend cores in this way without departing from the scope of this disclosure.

With reference to FIGS. 48, 49 and 50 and according to yet another embodiment of the present disclosure, a linear core store system 102 can replace the core storage 8. The actuation arm 5 is unnecessary in this embodiment and its motion is replaced with the linear motion of the 3D printer 1. In this embodiment, the coreless hotend 3 is moved into position by the 3D printer CNC controller 17 to be directly aligned with the stowed core 49. The core 49 is retained by the linear core storage end effector array 107. With specific reference to FIG. 49, the core exchanger CNC controller 16 is shown actuating the linear core storage pivot motor 105, which is connected to the linear core storage lift bar 103 by the linear core storage motor connection rod 106. The connecting rod 106 causes the linear core storage end effector array 107 to move towards the coreless hotend 3 while the 3D printer CNC controller adjusts the Z axis until the core 49 is fully inserted in the coreless hotend 3. The linear core storage pivot bars 104 keep the linear core storage core end effector array 107 correctly oriented during this process. With specific reference to FIG. 50, the core 49 is now locked into the coreless hotend 3 and is removed from the linear core storage end effector array 107 and the linear core storage lift bar 103 returns to its original position. The 3D printer CNC controller 17 may now continue with the print.

With reference to FIGS. 1 to 51, a three-dimensional (3D) printer is shown comprising a core exchanger mechanism to swap a plurality of hotend cores, the plurality of hotend cores containing a filament to print a 3D object; a hotend comprised of a first hotend core, the hotend connected to an extruder to heat and extrude the filament, the hotend and the extruder operatively engaged with the core exchanger mechanism; an actuation arm connected to the core exchange mechanism, the actuation arm configured to engage and selectively swap the plurality of hotend cores; and, a cutting mechanism to sever the filament, wherein the first hotend core is separated from the hotend once the filament is severed and swapped with a second core of the plurality of hotend cores of the core exchanger mechanism. The core exchanger mechanism may be further comprised of: a core storage device to store the plurality of hotend cores, the core storage device moveable to provide access to each one of the plurality of hotend cores; and, a controller electrically connected to the core storage device to move the core storage and provide access to each one of the plurality of hotend cores. The core exchanger mechanism may be rotatable about an axis and whereby the plurality of hotend cores are stored about a circumferential periphery of the core storage device. The core exchanger mechanism may be a linear array and whereby the plurality of hotend cores are stored about a longitudinal axis of the linear array of the core storage device. The actuation arm is rotatable about a point, the actuation arm securable to at least two hotend cores positioned at opposed ends of the actuation arm to provide simultaneous exchange of the at least two hotend cores. The cutting mechanism may be a disconnected cutter, the disconnected cutter positioned adjacent and untethered to the 3D printer, the disconnected cutter further comprised of: a motor to pivot a blade about a point and cut the filament; and, a core lock actuatable by the motor to unlock the first core of the plurality of cores. The cutting mechanism may be an integrated cutter, the integrated cutter tethered to the 3D printer, the integrated cutter comprised of: a motor to move a lock actuator from a locked position to an unlocked position, whereby a blade cuts the filament when moving from the locked position to the unlocked position; and, a core lock actuatable by the motor to unlock the first core of the plurality of cores when the lock actuator moves from the locked position to the unlocked position. The actuation arm may be a nozzle unscrewer, the nozzle unscrewer having an unscrewing arm and a nozzle unscrewing mechanism to replace a nozzle in the 3D printer.

With further reference to FIGS. 1 to 51, a coreless hotend for use with a three-dimensional (3D) printer is shown, the coreless hotend comprising a receptacle to receive and store a core of the 3D printer during 3D printing; and, a locking mechanism to releasably lock the core within the receptacle of the coreless hotend, wherein the locking mechanism is configured to release the core from the receptacle to replace the core with another core, the other core locked within the receptacle by the locking mechanism to provide for multi filament 3D printing. The coreless hotend may be further comprised of a heater block and cooling section to provide necessary heating and cooling to the coreless hotend; a mating surface connected to the heater block to thermally engage the heater block to the core; and, a heatbreak connected to the heater block and cooling section, the heatbreak acting a thermal bridge to isolate the heat of the heater block from the cooling section.

1. A three-dimensional (3D) printer comprising:
a core exchanger mechanism to swap a plurality of hotend cores, the plurality of hotend cores containing a filament to print a 3D object;
a hotend comprised of a first hotend core, the hotend connected to an extruder to heat and extrude the filament, the hotend and the extruder operatively engaged with the core exchanger mechanism;
an actuation arm connected to the core exchange mechanism, the actuation arm configured to engage and selectively swap the plurality of hotend cores; and,
a cutting mechanism to sever the filament,
wherein the first hotend core is separated from the hotend once the filament is severed and swapped with a second core of the plurality of hotend cores of the core exchanger mechanism.

2. The 3D printer of claim 1 wherein the core exchanger mechanism is further comprised of:
a core storage device to store the plurality of hotend cores, the core storage device moveable to provide access to each one of the plurality of hotend cores; and,
a controller electrically connected to the core storage device to move the core storage and provide access to each one of the plurality of hotend cores.

3. The 3D printer of claim 2 wherein the core exchanger mechanism is rotatable about an axis and whereby the plurality of hotend cores are stored about a circumferential periphery of the core storage device.

4. The 3D printer of claim 2 wherein the core exchanger mechanism is a linear array and whereby the plurality of hotend cores are stored about a longitudinal axis of the linear array of the core storage device.

5. The 3D printer of claim 1 wherein the actuation arm is rotatable about a point, the actuation arm securable to at least two hotend cores positioned at opposed ends of the actuation arm to provide simultaneous exchange of the at least two hotend cores.

6. The 3D printer of claim 1 wherein the cutting mechanism is a disconnected cutter, the disconnected cutter positioned adjacent and untethered to the 3D printer, the disconnected cutter further comprised of:
a motor to pivot a blade about a point and cut the filament; and,
a core lock actuatable by the motor to unlock the first core of the plurality of cores.

7. The 3D printer of claim 1 wherein the cutting mechanism is an integrated cutter, the integrated cutter tethered to the 3D printer, the integrated cutter comprised of:
a motor to move a lock actuator from a locked position to an unlocked position, whereby a blade cuts the filament when moving from the locked position to the unlocked position; and,
a core lock actuatable by the motor to unlock the first core of the plurality of cores when the lock actuator moves from the locked position to the unlocked position.

8. The 3D printer of claim 1 wherein the actuation arm is a nozzle unscrewer, the nozzle unscrewer having an unscrewing arm and a nozzle unscrewing mechanism to replace a nozzle in the 3D printer.

9. A coreless hotend for use with a three-dimensional (3D) printer, the coreless hotend comprising:
a receptacle to receive and store a core of the 3D printer during 3D printing; and,
a locking mechanism to releasably lock the core within the receptacle of the coreless hotend,
wherein the locking mechanism is configured to release the core from the receptacle to replace the core with another core, the other core locked within the receptacle by the locking mechanism to provide for multi filament 3D printing.

10. The coreless hotend of claim 9 further comprising:
a heater block and cooling section to provide necessary heating and cooling to the coreless hotend;
a mating surface connected to the heater block to thermally engage the heater block to the core; and,
a heatbreak connected to the heater block and cooling section, the heatbreak acting a thermal bridge to isolate the heat of the heater block from the cooling section.
